(19) United States
(12) Patent Application Publication
(10) Pub. No.: US 2022/0064520 A1
(43) Pub. Date: Mar. 3, 2022

(54) PROPPANT MATERIALS

(71) Applicant: Hexion Inc., Columbus, OH (US)

(72) Inventors: Leo ELDER, Stafford, TX (US); John W. GREEN, Stafford, TX (US); Andreina DEWENDT, Stafford, TX (US); Chunhui ZHAO, Stafford, TX (US); John M. TERRACINA, Stafford, TX (US)

(21) Appl. No.: 17/004,713

(22) Filed: Aug. 27, 2020

(51) Int. Cl. C09K 8/80; C09J 161/06

(52) U.S. Cl. CPC C09K 8/80; C08K 7/00; C09J 161/06

(57) ABSTRACT

The embodiments described herein generally relate proppant materials. In one embodiment, a material is provided a substrate and an adhesive composition disposed on the substrate, wherein the adhesive composition comprises an adhesive agent, a coupling agent, and optionally, a processing aid, an internal breaker, or both, and a buoyancy additive disposed on the adhesive composition.

### FIELD OF THE INVENTION

The present invention relates to compositions and products in various applications of hydraulic fracturing operations. The present invention particularly relates to compositions and products for enhanced buoyancy and for conductivity enhancements in hydraulic fracturing operations.

### BACKGROUND

In the oil and gas industry, each reservoir fracture network is different and complex, especially if in situ natural fractures are formed. It is hard for conventional proppant particles to be transported into these secondary fractures and full production recovery cannot be achieved. Optimization of proppant placement during hydraulic fracturing can be critical to mitigate this issue. Although current technology calls for the use of high viscosity fluid, such as gels, to achieve maximum transport, this technology can be expensive with the extra additives for increasing fracturing fluid viscosity, or crosslinkers to change the viscous fluid to a pseudoplastic fluid, and usually complicates the hydraulic fracturing process. Additionally, currently available products provide less than desirable performance.

It would be desirable if compositions and methods could be devised that would allow proppants to have the ability to be suspended in gelled and non-gelled fracturing fluids as compared to the prior art.

### SUMMARY

The embodiments described herein generally relate to proppant materials. In one embodiment, a material is provided comprising a substrate and an adhesive composition disposed on the substrate, wherein the adhesive composition comprises an adhesive agent, a coupling agent, and optionally, a processing aid, an internal breaker, or both, and a buoyancy additive disposed on the adhesive composition.

The embodiments described herein also generally relate to methods and chemical compositions for coating substrate with an adhesive composition. In one embodiment, a composition is provided comprising a reaction product of a polyacid selected from the group consisting of an aromatic polyacid, an aliphatic polyacid, an aliphatic polyacid with an aromatic group, and combinations thereof, or a diglycidyl ether; and a polyamine; and one or more compounds selected from the group consisting of a branched aliphatic acid, a cyclic aliphatic acid with a cyclic aliphatic group, a linear aliphatic acid, and combinations thereof.

In one embodiment, an adhesive composition is provided comprising a reaction product of a polyacid selected from the group consisting of an aromatic polyacid, an aliphatic polyacid, an aliphatic polyacid with an aromatic group, and combinations thereof, or a diglycidyl ether; and a C2-C18 polyamine; and one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof.

In another embodiment, a particulate material is provided, including a substrate and an adhesive composition including a polyol, an N-cyclohexylsulfamate compound, a reaction product of a polyacid selected from the group consisting of an aromatic polyacid, an aliphatic polyacid, an aliphatic polyacid with an aromatic group, and combinations thereof, or a diglycidyl ether; and a polyamine; and one or more compounds selected from the group consisting of a branched aliphatic acid, a cyclic aliphatic acid with a cyclic aliphatic group, a linear aliphatic, and combinations thereof; or a combination thereof. A buoyancy additive may be disposed on the adhesive composition.

In another embodiment, a process for forming a proppant is provided, including providing a substrate, and disposing an adhesive composition thereon as described herein. The process may further include disposing a buoyancy additive on the adhesive composition.

In another embodiment, a fracturing fluid composition is provided comprising a fracturing fluid and an additive composition including a polyol, a N-cyclohexylsulfamate compound, a reaction product of a diglycidyl ether or a polyacid selected from the group consisting of an aromatic polyacid, an aliphatic polyacid, an aliphatic polyacid with an aromatic group, and combinations thereof; and a polyamine; and one or more compounds selected from the group consisting of a branched aliphatic acid, a cyclic aliphatic acid with a cyclic aliphatic group, a linear aliphatic, and combinations thereof; or a combination thereof; and a buoyancy additive disposed on the adhesive composition.

In another embodiment, a material is provided including a substrate, an adhesive composition disposed on the substrate, and a buoyancy additive disposed on the adhesive composition, wherein the adhesive composition comprises a polyol, an N-cyclohexylsulfamate compound, a reaction product of a diglycidyl ether or a polyacid selected from the group consisting of an aromatic polyacid, an aliphatic polyacid, an aliphatic polyacid with an aromatic group, and combinations thereof, a polyamine, one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof; or combinations thereof.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

So that the manner in which the features, advantages, and objects of the invention, as well as others which will become apparent, are attained, and can be understood in more detail, more particular description of the invention briefly summarized above may be had by reference to the embodiments thereof which are illustrated in the appended drawings that form a part of this specification. It is to be noted, however, that the drawings illustrate only a preferred embodiment of the invention and are therefore not to be considered limiting of its scope as the invention may admit to other equally effective embodiments.

FIG. 1 is a graph showing the comparison of viscosity over time at 0 gallons per thousand gallons of 2% KCl fluid (GPT) of coated proppants with some embodiments of this invention;

FIG. 2 is a graph showing the comparison of viscosity over time at 1 gallons per thousand gallons of 2% KCl fluid (GPT) of coated proppants of some embodiments of this invention;

FIG. 3 is a graph showing the comparison of viscosity over time at 2 gallons per thousand gallons of 2% KCl fluid (OPT) of coated proppants with some embodiments of this invention;

FIG. 4 is a graph showing the comparison of viscosity over time at 4 gallons per thousand gallons of 2% KCl fluid (GPT) of coated proppants with some embodiments of this invention;

FIG. 5 is a graph showing the comparison of viscosity over time at 8 gallons per thousand gallons of 2% KCl fluid (GPT) of coated proppants with some embodiments of this invention; and

FIG. 6 is a graph showing the comparison of viscosity over time at 16 gallons per thousand gallons of 2% KCl fluid (GPT) of coated proppants with some embodiments of this invention.

### DETAILED DESCRIPTION

Embodiments of the invention are compositions for coating substrates. In one embodiment, a particulate material is formed by coating a substrate material with an adhesive composition. A buoyancy additive may then be disposed on the adhesive composition.

In one embodiment, a composition or agent is generally considered adhesive when the composition before or after application exhibits adhesive strength above 1 N/m² or work of adhesion above 1 J/m². In one embodiment, a proppant is considered buoyant when the proppant exhibits suspension, has substantially neutral buoyancy in the liquid, or other non-settling behavior in the presence of a liquid medium as understood by one skilled in the art. The term “substantially neutrally buoyant” may be described as the proppant having an apparent specific gravity close to the apparent specific gravity of a carrier fluid, water, fracturing fluid, or other medium to allow pumping and satisfactory placement of the proppant using the fluid or medium.

It is believed that the tackifying property of the adhesive composition adheres the buoyancy additive disposed on the adhesive composition, for example, glycerin and water-swellable gums and/or water-swellable fibers, to the proppant surface, imparting near neutral buoyancy when the proppant coated with the adhesive composition and buoyancy additive coated particulate is mixed with an aqueous fluid. It is believed such buoyancy enhanced proppants provide enhanced conductivity as a secondary benefit that results from more optimal placement of the enhanced buoyancy proppant during hydraulic fracturing. The enhanced buoyancy proppant penetrates deeper into fractures because of its enhanced settling properties when compared to uncoated proppant substrate or traditional resin coated proppant substrate. While not a primary benefit, the adhesive composition may result in dust reduction or mitigation.

The substrate material may be any organic or inorganic particulate material.

Suitable inorganic particulate materials include inorganic materials (or substrates), such as exfoliated clays (for example, expanded vermiculite), exfoliated graphite, blown glass or silica, hollow glass spheres, foamed glass spheres, cenospheres, foamed slag, sand, naturally occurring mineral fibers, such as zircon and mullite, ceramics, sintered ceramics, such as sintered bauxite or sintered alumina, other non-ceramic refractories such as milled or glass beads, and combinations thereof. Exemplary inorganic substrate materials may be derived from silica sand, milled glass beads, sintered bauxite, sintered alumina, mineral fibers such as zircon and mullite, or a combination comprising one of the inorganic substrate materials.

Suitable organic particulate materials include organic polymer materials, naturally occurring organic substrates, and combinations thereof. The organic polymer materials may comprise any of the polymeric materials described herein that are carbon-based polymeric materials. Another particulate material is dust, which can be organic or inorganic depending on the source material from which it is derived.

Naturally occurring organic substrates are ground or crushed nut shells, ground or crushed seed shells, ground or crushed fruit pits, processed wood, ground or crushed animal bones, or a combination comprising at least one of the naturally occurring organic substrates. Examples of suitable ground or crushed shells are shells of nuts such as walnut, pecan, almond, ivory nut, brazil nut, ground nut (peanuts), pine nut, cashew nut, sunflower seed, Filbert nuts (hazel nuts), macadamia nuts, soy nuts, pistachio nuts, pumpkin seed, or a combination comprising at least one of the foregoing nuts. Examples of suitable ground or crushed seed shells (including fruit pits) are seeds of fruits such as plum, peach, cherry, apricot, olive, mango, jackfruit, guava, custard apples, pomegranates, watermelon, ground or crushed seed shells of other plants such as maize (e.g., corn cobs or corn kernels), wheat, rice, jowar, or a combination comprising one of the foregoing processed wood materials such as, for example, those derived from woods such as oak, hickory, walnut, poplar, mahogany, including such woods that have been processed by grinding, chipping, or other form of particalization. An exemplary naturally occurring substrate is a ground olive pit.

The substrate may also be a composite particle, such as at least one organic component and at least one inorganic component, two or more inorganic components, and two or more organic components. For example, the composite may comprise an organic component of the organic polymeric material described herein having inorganic or organic filler materials disposed therein. In a further example, the composite may comprise an inorganic component of any of the inorganic polymeric material described herein having inorganic or organic filler materials disposed therein.

Inorganic or organic filler materials include various kinds of commercially available minerals, fibers, or combinations thereof. The minerals include at least one member of the group consisting of silica (quartz sand), alumina, mica, meta-silicate, calcium silicate, calcine, kaoline, talc, zirconia, boron, glass, and combinations thereof. Fibers include at least one member selected from the group consisting of milled glass fibers, milled ceramic fibers, milled carbon fibers, synthetic fibers, and combinations thereof.

The substrate material may have any desired shape such as spherical, egg-shaped, cubical, polygonal, or cylindrical, among others. It is generally desirable for the substrate material to be spherical in shape. Substrate materials may be porous or non-porous. Preferred substrate particles are hard and resist deforming. Alternatively, the substrate material may be deformable, such as a polymeric material. Deforming is different from crushing wherein the particle deteriorates usually creating fines that can damage fracture conductivity. In one embodiment, the inorganic substrate material does not melt at a temperature below 450° F. or 550° F.

For proppant formation, the substrate may be in the form of individual particles that may have a particle size in the range of ASTM sieve sizes (USA Standard Testing screen numbers) from about 6 to 325 mesh (screen openings of about 3360 or about 0.132 inches to about 44 μm or 0.0017 inches). Typically, for proppant or gravel pack, individual particles of the particulate substrate have a particle size in the range of USA Standard Testing screen numbers from about 8 to about 100 mesh (screen openings of about 2380 μm or about 0.0937 inches to about 150 μm or about 0.0059 inches), such as from 20 to 80 mesh (screen openings of about 841 μm or about 0.0311 inches to about 177 μm or 0.0070 inches), for example, 40 to 70 mesh, (screen openings of about 420 μm or about 0.0165 inches to about 210 μm or 0.0083 inches) may be used to define the particle size.

In one embodiment of the invention, the proppant material size may be 20/40 mesh, 30/50 mesh, 40/70 mesh, and 70/140 mesh. Alternatively, the proppant material size may vary from about 40/140 to about 80/140 mesh, which is commonly referred to as “100 mesh”. A size of a 20/40 mesh is commonly used in the industry as a material having a size between a 20 mesh and 40 mesh as described herein. Smaller mesh proppants, such as 40/70 mesh proppants, may be used in low viscosity fracture fluids, and larger mesh proppants, such as 20/40 mesh proppants, may be used in high viscosity fracture fluids. In one embodiment, the adhesive composition includes an adhesive agent and a coupling agent, and optionally, a processing aid, an internal breaker, or both. The adhesive agent comprises from about 80% to about 99.5%, such as from about 88% to about 99%, of the adhesive composition. The coupling agent comprises from about 0.5% to about 20%, such as from about 1% to about 12%, of the adhesive composition. If present, the processing aid may comprise from about 0.09% to about 3%. If present, the internal breaker may comprise from about 0.01% to about 1%. The adhesive composition may further include water. If present the water forms the remainder of any weight percent of the adhesive composition.

In one embodiment, the adhesive agent may include one or more of a polyol, N-cyclohexylsulfamate, a phenol-aldehyde resole resin, a reaction product of a polyacid and a polyamine, or combinations thereof and one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof. The reaction product of a polyacid and a polyamine forms an adduct.

The polyol may include two or more hydroxyl groups, which are preferably diols and triols. Examples of suitable polyols include propane-1,2,3-triol, glycerol, propanetriol, 1,2,3-trihydroxypropane, 1,2,3-propanetriol, crude glycerin, and combination thereof. Other suitable polyols include polyether polyols, such as the Caradol™ polyether polyols available from Shell Chemical Company. Crude glycerin includes compositions that are not purified and are commonly used and commercially available in the industry. Other components in crude glycerin include methanol, water, and various organic compounds based on the precursor material, among others. However, specifications for crude glycerin other than the glycerol content vary widely.

Crude glycerins are separated from both the 97+% Technical Grade and the 99+% Refined Grade. Refined Glycerin can also be further classified as Kosher, USP, or USP Kosher depending upon source and handling. One example of crude glycerin is 82-85% glycerin, which crude glycerin is most common as most bio-diesel plants do not upgrade beyond 82-85%. Another example of crude glycerin is 92-95% glycerin. The 92-95% crude glycerin is much less common as relatively few biodiesel plants either produce or upgrade to the 92-95% crude glycerol levels.

In one embodiment of the invention, the adhesive agent may include N-cyclohexylsulfamate compounds. The N-cyclohexylsulfamate compounds may include sodium N-cyclohexylsulfamate. N-cyclohexylsulfamate is also referenced by the CAS (Chemical Abstracts Service) Number: 68476-78-8, EPA (United States Environmental Protection Agency) tracking number 439588, and may be in the form of molasses or beet molasses. N-cyclohexylsulfamate compounds in the form of molasses may further contain Water CAS #7732-18-5, sucrose CAS #57-50-1, and potassium sulfate CAS #7778-80-5. Alternatively, the N-cyclohexylsulfamate compound or composition may be free of sugar, such as in the form of sucrose or other accepted sugar compound known to one skilled in the art.

The polyamine may be any amine having two or more amine groups. Suitable polyamines include diamines. Suitable diamines include polyethylenepolyamines, C2-C12 linear diamines, cyclic diamines, diamine with aromatic content, polyetherdiamines, polyoxyalkylene diamines, and combinations thereof. Examples of diamines include diamines selected from the group consisting of ethylenediamine, diethylenetriamine, triethylenetetraamine, bis(aminomethyl)cyclohexane, phenylenediamine, naphthalene diamine, xylene diamine, polypropylene oxide diamine, and combinations thereof. Other suitable amines include higher amines from reactions of diamines such as xylenediamine with epichlorohydrin such as Gaskamine 328 (Mitsubishi Gas Chemical Co). Other polyamines include triamines and tetramines, for example, polyethertriamine (Jeffamine T-403 available from Huntsman of Houston, Tex.) and triethylenetetramine (TETA), and combinations thereof.

In one embodiment of the polyamines, a diamine is selected from the group consisting of polyethylenepolyamines, C2-C12 diamines, polyetherdiamines, and combinations thereof. Examples of these diamines include diamines selected from the group consisting of ethylenediamine, diethylenetriamine, triethylenetetraamine, and combinations thereof.

The reaction product includes from about 10 wt. % to about 60 wt. %, such as from about 15 wt. % to about 45 wt. %, of the polyamine; and from about 40 wt. % to about 90 wt. %, such as from about 55 wt. % to about 85 wt. % of the polyacid based on the weight of the reaction product. The polyamine and the polyacid may also be provided to form the reaction mixture at a molar ratio of polyamine to polyacid of about 2:1 to about 1:2.

The polyacid may be selected from the group consisting of an aromatic polyacid, an aliphatic polyacid, an aliphatic polyacid with an aromatic group, and combinations thereof.

The polyacid may comprise a diacid. Suitable diacids include diacids selected from the group consisting of aromatic diacid, aliphatic diacid, aliphatic diacid with an aromatic group, and combinations thereof. The diacids may be saturated diacids or unsaturated diacids. The diacids may also be C2-C24 diacids and/or dimerized fatty acids. Suitable examples of diacids include terephthalic acid, phthalic acid, isophthalic acid, oxalic acid, malonic acid, succinic acid, glutaric acid, adipic acid, pimelic acid, suberic acid, azelaic acid, maleic acid, fumaric acid, muconic acid, and combinations thereof.

The aliphatic diacid with aromatic group(s) block(s) between the acid groups may be represented by following general formulas:

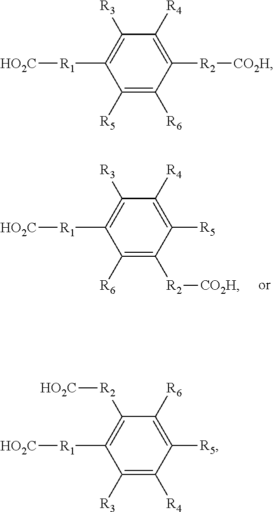

and combinations thereof, wherein each of R1 and R2 are independent functional groups selected from the group consisting of C1-C12 alkyl, alkanoxy, alkylamino, and alkylcarboxy, and each of R3, R4, R5, and R6 are independent functional groups selected from the group consisting of hydroxyl (—OH), amino, nitro, sulfonyl, C1-C12 alkyl, alkanoxy, alkylamino, and alkylcarboxy.

The aromatic diacids may also be substituted with a functional group selected from the group consisting of amine, hydroxyl (—OH), C1-C12 alkyl, alkylamino, alkanoxy, alkylenoxy, alkylcarboxy, alkylnitro, alkylsulfonyl, and wherein the substitution on the aromatic ring is in one or more positions. For example, the terephthalic acid, the phthalic acid, and the isophthalic acid, may be substituted with a functional group selected from the group consisting of amine, hydroxyl (—OH), C1-C12 alkyl, alkylamino, alkanoxy, alkylenoxy, alkylcarboxy, alkylnitro, alkylsulfonyl, and wherein the substitution on the aromatic ring is in one or more positions.

In one embodiment, the adhesive agent includes a reaction product of a triacid and a polyamine; and one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof. The reaction product of the triacid and the polyamine forms an adduct.

Suitable triacids include citric acid, isocitric acid, aconitic acid, propane-1,2,3-tricarboxylic acid, trimesic acid, and the combinations thereof.

In one embodiment, the adhesive agent includes a reaction product of a tetracid and a polyamine; and one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof. The reaction product of the tetracid and the polyamine forms an adduct.

Suitable tetracids include ethylenediaminetetraacetic acid (EDTA), furantetracarboxylic acid, methanetetracarboxylic acid, ethylenetetracarboxylic acid, benzenetetracarboxylic acid, and benzoquinonetetracarboxylic acid, and the combinations thereof.

In another embodiment, the adhesive agent includes a reaction product of a polyamine and a diglycidyl ether; and one or more compounds selected from the group consisting of a branched aliphatic acid having C2-C26 alkyl group, a cyclic aliphatic acid with C7-C30 cyclic aliphatic group, a linear aliphatic acid having . C2-C26 alkyl group, and combinations thereof. The reaction product of the diglycidyl ether and the polyamine forms an adduct.

The reaction product includes from about 10 wt. % to about 60 wt. %, such as from about 15 wt. % to about 45 wt. %, of the polyamine, and from about 40 wt. % to about 90 wt. %, such as from about 55 wt. % to about 85 wt. %, of the diglycidyl ether based on the weight of the reaction product. The polyamine and the diglycidyl ether may also be provided to form the reaction mixture at a molar ratio of polyamine to diglycidyl ether of about 2:1 to about 1:2.

Examples of suitable diglycidyl ethers are selected from the group consisting of diglycidyl ether of bisphenol A, diglycidyl ether of bisphenol F, diglycidyl ether of bisphenol B, diglycidyl ether of bisphenol C, diglycidyl ether of bisphenol E, diglycidyl ether of bisphenol AP, diglycidyl ether of bisphenol AF, diglycidyl ether of bisphenol BP, diglycidyl ether of bisphenol G, diglycidyl ether of bisphenol M, diglycidyl ether of bisphenol S, diglycidyl ether of bisphenol P, diglycidyl ether of bisphenol PH, diglycidyl ether of bisphenol TMC, diglycidyl ether of bisphenol Z, and combinations thereof.

In another embodiment, the adhesive agent includes a reaction product of a polyamine and a diacid, a diglycidyl ether, or a combination thereof; and one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof. The reaction product of the polyamine and the diacid, a diglycidyl ether forms an adduct.

The reaction product includes from about 10 wt. % to about 80 wt. %, such as from about 18 wt. % to about 50 wt. %, of the polyamine, and from about 20 wt. % to about 90 wt. %, such as from about 50 wt. % to about 82 wt,%, of the diacid, the diglycidyl ether, or a combination thereof based on the weight of the reaction product. The polyamine and the diacid, diglycidyl ether may also be provided to form the reaction mixture at a molar ratio of polyamine to the diacid, the diglycidyl ether, or a combination thereof of about 2:1 to about 1:2.

The composition may comprise from about 25 wt. % to about 96 wt. %, such as from about 45 wt. % to about 80 wt. %, of the reaction product and may comprise from about 4 wt. % to about 75 wt. %, such as from about 20 wt. % to about 55 wt. % of the one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof.

The polyamine and the diglycidyl ether may also be provided to form the reaction mixture at a molar ratio of polyamine to the diacid, the diglycidyl ether, or a combination thereof of about 2:1 to about 1:2, with the one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof being added to the composition at a molar ratio of polyamine to the diacid, the diglycidyl ether, or a combination thereof to the one or more compounds of about 2:2:1 to about 2:6:5. For example, an aliphatic acid—amine-diacid-amine-aliphatic acid structure, has a molar ratio of 2:2:1 ratio, and an aliphatic acid—(amine-diacid) 5-amine-aliphatic acid has a structure with a molar ratio of 2:6:5 ratio.

The branched aliphatic acid having a C2-C26 alkyl group may be selected from the group consisting of neopentanoic acid, neononanoic acid, neodecanoic acid, neotridecanoic acid, and combinations thereof. Examples of such acids include Hexion's Versatic™ Acid 5, 9, 10, 913, and 1019 acids. The branched aliphatic acid having a C2-C26 alkyl group may comprise from about 9 wt. % to about 65 wt. %, such as from about 25 wt. % to about 50 wt. %, of the composition.

The cyclic aliphatic acid with C7-C30 cyclic aliphatic group may be selected from the group consisting of rosin, naphthenic acid, and combinations thereof. Examples of rosins include rosin acid, tall oil rosin, or gum rosin. All rosins are provided the CAS number 8050-09-7. The cyclic aliphatic acid with C7-C30 cyclic aliphatic group may comprise from about 20 wt. % to about 87 wt. %, such as from about 25 wt. % to about 65 wt. %, of the composition.

The linear aliphatic acid having C2-C26 alkyl group may be selected from the group consisting of unsaturated C2-C26 fatty acids, saturated C2-C26 fatty acids, and combinations thereof. Examples of unsaturated fatty acids include tall oil fatty acid, myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and combinations thereof. Examples of saturated fatty acids include caprylic acid, capric acid, lauric acid, myristic acid, palmitic acid, stearic acid, arachidic acid, behenic acid, lignoceric acid, cerotic acid, and combinations thereof. The linear aliphatic acid having C2-C26 alkyl group may be any plant and animal fatty acid that are the combinations of above unsaturated and saturated fatty acids such as tall oil fatty acid, rosin acid, and fatty acids made from chicken fat, lard, beef tallow, canola oil, flaxseed oil, sunflower oil, corn oil, olive oil, sesame oil, peanut oil, cottonseed oil, palm oil, butter, and cocoa butter, palm kernel oil, coconut oil, and the alike. One example is tall oil fatty acids, and another example is rosin acid. The linear aliphatic acid having C2-C26 alkyl group may comprise from about 20 wt. % to about 87 wt. %, such as from about 25 wt. % to about 65 wt,%, of the composition.

In one embodiment of the invention, the adhesive agent is made with the diacid comprising terephthalic acid, the polyamine comprising diethylenetriamine, and the linear aliphatic acid having C2-C26 alkyl group comprising tall oil fatty acid (TOFA). Such a composition is suitable for use as a dust control composition, among other uses.

In one embodiment of the invention, the adhesive agent is made with the diacid comprising terephthalic acid, the polyamine comprising diethylenetriamine, and the cyclic aliphatic acid with C7-C30 cyclic aliphatic group comprises rosin. Such a composition is suitable for use as a proppant flow-back control composition in a hydraulic fracturing process, among other uses.

In one embodiment of the invention, the adhesive agent is made with the diacid comprising terephthalic acid, the polyamine comprising diethylenetriamine, and the cyclic aliphatic acid with C7-C30 cyclic aliphatic group comprises rosin. Such a composition, when combined with a cross-link agent, is suitable for use as a proppant flow-back control and consolidating agent for proppant pack and gravel pack in a hydraulic fracturing process, among other uses.

In one embodiment of the invention, the adhesive agent is made with the diacid comprising terephthalic acid, the polyamine comprising diethylenetriamine, and the cyclic aliphatic acid with C7-C30 cyclic aliphatic group comprises rosin. Such a composition, when combined with a cross-link agent, is suitable for use as agents for consolidating downhole formation of the well in a hydraulic fracturing process, among other uses.

Alternatively, a cross-linking agent may be added to the composition. The cross-link agents may include epoxy compounds. Examples of suitable cross-link agents include a diglycidyl ether selected from the group consisting of diglycidyl ether of bisphenol A, diglycidyl ether of bisphenol F, diglycidyl ether of bisphenol B, diglycidyl ether of bisphenol C, diglycidyl ether of bisphenol E, diglycidyl ether of bisphenol AP, diglycidyl ether of bisphenol AF, diglycidyl ether of bisphenol BP, diglycidyl ether of bisphenol G, diglycidyl ether of bisphenol M, diglycidyl ether of bisphenol S, diglycidyl ether of bisphenol P, diglycidyl ether of bisphenol PH, diglycidyl ether of bisphenol TMC, diglycidyl ether of bisphenol Z, and combinations thereof. For example, diglycidyl bisphenol ether may be used as a cross-link agent for R-diamine-diacid-diamine-R type adhesives. In another example, the diglycidyl bisphenol ether also can be used to form R-diamine-diglycidyl bisphenol ether-diamine-R type adhesive.

In one embodiment, the adhesive agent comprises a formula selected from the group of:

R₁-dAm-(dAc-dAm [symbol] ₙ-R₂ (Structure 1),

R₁-dAm-(dGE-dAm [symbol] ₙ-R₂ (Structure 2),

or a mixture thereof, wherein n is 0 to 10, R1 and R2 are each independently selected from the group of a branched aliphatic acid having C2-C26 alkyl group, cyclic aliphatic acid with C7-C30 cyclic aliphatic group, a linear aliphatic acid having C2-C26 alkyl group, or a combination thereof, the dAm comprises a polyamine, such a diamine described herein, dAc comprises a diacid as described herein, and dGe comprises a diglycidyl ether as described herein.

In another embodiment, the diacid comprises terephthalic acid, the polyamine comprises diethylenetriamine, and the reaction product comprises:

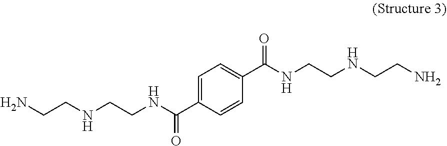 [SMILES: NCCNCCNC(=O)c1ccc(C(=O)NCCNCCN)cc1]

The reaction product is then reacted with (a branched aliphatic acid having C2-C26 alkyl group) versatic acid, (the cyclic aliphatic acid with C7-C30 cyclic aliphatic group) rosin (Rosin), (the linear aliphatic acid having C2-C26 alkyl group) tall oil fatty acid (TOFA), or a combination thereof and the composition comprises:

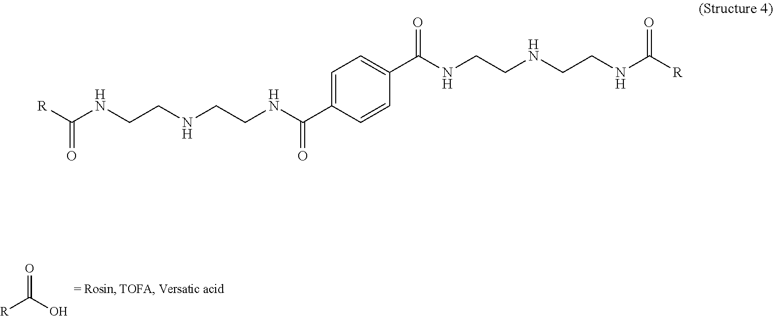

In another embodiment, the adhesive agent includes a reaction product from concurrently reacting components a)-c) which are a) a polyamine, b) a diacid, a diglycidyl ether, or a combination thereof, and c) one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof. The reaction product of a), b), and c) forms composition.

In another embodiment, the adhesive agent comprises a formula selected from the group of:

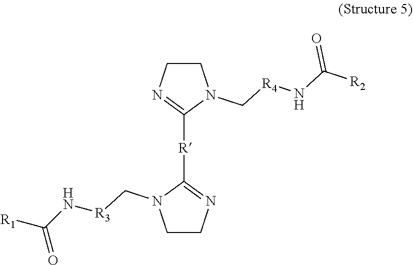

Wherein R′ is the central organic segment of a diacid (HO₂C—R′—CO₂H) as described herein. R₁ and R₂ are each independently selected from the group of a branched aliphatic acid having C2-C26 alkyl group, cyclic aliphatic acid with C7-C30 cyclic aliphatic group, a linear aliphatic acid having C2-C26 alkyl group, or a combination thereof. R₃ and R₄ are alkyl, or alkylamino groups such as —(CH₂—)ₙ—, or —(CH₂CH₂NH)ₙ—, or combination thereof and n is from 0 to 10. Structure 5 is a bis-imidazoline component. Structure 5 is derived from a diacid (HO₂C—R′—CO₂H) as described herein, with R′ being the organic segment to which the carboxylic acid groups are attached.

The composition described herein for Structures 1, 2, 4, and 5 can further be modified by grafting the backbone through oxyalkylation of the secondary amine, or reacting the secondary amine with ethylene oxide, propylene oxide or butylene oxide in any ratio, or sequences, or molar mass.

The composition described herein for Structures 1, 2, 4, and 5 can further be modified by reacting the secondary amine with epoxides. Suitable epoxides include an alkylglycidyl ether, such as butylglycidyl ether, p-tert-butyl phenyl glycidyl ether, cresyl glycidyl ether, castor oil glycidyl ether, glycidyl ester of neodecanoic acid, and combinations thereof.

The composition described herein for Structures 1, 2, 4, and 5 can further be modified by grafting the main chain through amidation of the secondary amine, or through the esterification of the hydroxyl with carboxylic acids if there are hydroxyl groups available for reaction. Suitable carboxylic acids include any carboxylic acids described herein including, for example, tall oil fatty acid, tallow fatty acid, neoalkanoic acid (such as Hexion's Versatic™ acid described herein), and combinations thereof.

The composition described herein for Structures 1, 2, 4, and 5 can further be modified by quaterizing the secondary amine. Suitable compounds for quaterizing the secondary amine include, but not limited to, benzyl chloride, acrylic acid, and combinations thereof.

The composition described herein for Structures 1, 2, 4, and 5 can further be reacted by oxidizing the secondary amine to an amine oxide.

In one embodiment, the adhesive agent may be N-cyclohexylsulfamate in the form of beet molasses, and may be used in combinations with a reaction product of a polyacid and a polyamine. In another embodiment, the adhesive agent may be a reaction product of a polyacid and a polyamine. In yet another embodiment, the adhesive agent may be crude glycerin, such as 82-85% glycerin or 92-95% glycerin, alone or in combination. A phenol-aldehyde resole resin was also used by itself.

The phenol-aldehyde resole resin may be any phenol-aldehyde resin known to one skilled in the art. The aldehyde may be formaldehyde, one or more aldehydes having C1-C12 carbon atoms groups, and combinations thereof. The phenolic compound may be a phenolic monomer selected from the group consisting of phenol, cresol, resorcinol, xylenol, ethyl phenol, alkylresorcinols, and combinations thereof, among others.

In the practice of this invention, coupling agents may be employed in the adhesive composition. It is desirable to include a silane additive to ensure good bonding between the materials, such as polymeric materials, and the substrate as a coupling agent. The use of organofunctional silanes as coupling agents to improve interfacial organic-inorganic adhesion is especially preferred.

Such coupling agents include, for example, organosilanes which are known coupling agents. The use of such materials may enhance the adhesion between the binder (adhesive) and the filler (proppant substrate). Examples of useful coupling agents of this type include amino silanes, epoxy silanes, mercapto silanes, hydroxy silanes, and ureido silanes. The use of organofunctional silanes as coupling agents to improve interfacial organic-inorganic adhesion is especially preferred. These organofunctional silanes are characterized by the formula I:

R¹—Si—(OR²)₃ I,

where R^{I} represents a reactive organic function and OR² represents a readily labile alkoxy group such as OCH₃ or OC₂H₅. Particularly useful for coupling phenolic or furan resins to silica are the amino functional silanes of which Union Carbide A1100 (gamma aminopropyltriethoxysilane) is an example. The silane may be premixed with the resin or added to the mixer separately.

The coupling agent may comprise from about 0.5 wt. % to about 20 wt. %, such as from about 1 wt. % to about 12 wt. %, of the adhesive composition.

The optional processing aid may comprise polyols, paraffins, silicones, waxes, and combinations thereof. One examples of a processing aid is Concentrated Separator By-Product (CSB). CSB is a secondary molasses produced during the separation of sugars from normal sugar beet molasses. It contains most of the molasses components but is lower in sugar content than ordinary molasses and crude glycerin described herein. The processing aid and internal breaker described herein may be the same compound in one embodiment.

CSB may be used as a processing aid when the adhesive agent is not a polyol or contains a polyol. The optional processing aid is an additive added during the production of the coated proppant and may end up in the finished product. It is believed that processing aids can improve the coated proppant process through the manufacturing mixer by not allowing the particles to stick together or being cohesive. If particles are cohesive, they cling to one another to form aggregates. The processing aid is also believed to improve the fluidity and transport of the proppant though sieves, conveyers, and pumps, and can reduce the dust produced during and after the manufacturing process of the coated proppant. Processing aids that are retained in the finished product can also help with the release of the active ingredients on the coated proppant in the oilfield blending tub and downhole in the fractured zone.

The adhesive composition may further comprise a solvent. Suitable solvents include a solvent selected from the group consisting of aromatic solvents, ethers, alcohols, water, and combinations thereof. Examples of aromatic solvents include toluene, xylenes, naphthas, and combinations thereof. Examples of suitable naphtha solvents are heavy aromatic naphtha solvents such as Aromatic 100, Aromatic 150, and Aromatic 200, commercially available from ExxonMobil Inc. Examples of ethers include diglyme, triglyme, polyglyme, proglyme (BASF), ethylene glycol butyl ether (EGBE), tripropyleneglycol methyl ether, ethyleneglycol butyl ether, dipropylene glycol ethyl ether, tripropylene glycol ethyl ether, diethylene glycol ethyl ether, diethyleneglycol butyl ether, and combinations thereof. Examples of alcohols include methanol, isopropanol, ethanol, propanol, butanol, ethoxytriglycol, methoxytriglycol, 2,2-dimethyl-4-hydroxymethyl-1,3-dioxolane (Solvay SL 191), and combinations thereof.

In one embodiment, a solvent system or solvent mixture is designed to allow transport and delivery of the coating material at the individual interfaces between the individual sand grains. These solvent combinations are also designed to allow good solubility and good wetting of the sand surface. The solvent system is designed to have a water-soluble component or components that assist transport and delivery of the coating material in the slurry, but diffuse into the aqueous matrix after coating to allow a viscous, adhesive coating on the sand surface. The subsequent diffusion of the oil soluble component or components from the coating layer into the oil matrix ensures a rigid adhesive bond between the sand grains and consequently the formation of a solid core.

The adhesive composition may further include an optional internal breaker. Suitable internal breakers include strong acids, peroxides, enzymes, percarbonates, persulfates, hypochlorites. and combinations thereof. The optional internal breaker may function as an oxidizing agent. Suitable internal breaking agents that may function as oxidizing agents include a bromate breaking agent, a chlorite breaking agent, a peroxide breaking agent, a perborate breaking agent, a percarbonate breaking agent, a perphosphate breaking agent, or a persulfate breaking agent, or combinations thereof. Examples of internal breakers include sodium percarbonate, sodium persulfate, sodium hypochlorite, sodium chlorite, and combinations thereof.

The one or more internal breakers may comprise from about 0.01 wt. % to about 0.50 wt. %, such as from about 0.03 wt. % to about 0.10 wt. %, of the coated proppant material. One example of an oxidizing agent, which are also known as breakers, includes sodium persulfate.

Breakers are added to the oilfield fracture stimulation fluid to bring the stimulation fluid to a low viscosity once the proppant is placed, which minimizes the return of proppants and maximizes permeability of the fracture, which in turn maximizes the return of fluids to the surface of the well. Traditional oilfield breakers, external breakers, are specialized chemicals that are added directly to the blender tub and pumped down hole to ‘break’ the polymers and crosslinkers in the frac fluid, reducing the fluid viscosity and allowing easier cleanup after the treatment. In contrast, internal breakers are encapsulated in the proppant coating itself and pumped down hole to ‘break’ the adhesives buoyancy additives of the present invention, for example guar and/or xanthan gums, increasing the effectiveness of the ‘break’ of gel at the proppant in the fractured zone. Alternatively, an internal breaker may be used as an external breaker in combination with the proppant material described herein.

The adhesive compositions herein may function as a pressure sensitive adhesive when the composition is in a (high viscosity) liquid state or semi-liquid state. In one embodiment, the composition may further include solvents, plasticizers, wetting agents, polymers, and combinations thereof.

The adhesive composition described herein may be used for coating a proppant, used for adhesive applications, such as a tackifier for hot-melt adhesive applications, or pressure sensitive adhesive, used for paints and other large surface coatings. Additionally, the adhesive coating may be used for dust suppression, such as in agricultural, coal, stone (gravel dust), cement, concrete, and road applications, among others. In hydraulic fracturing processes, the adhesive composition may also be useful for proppant flow-back control, the consolidation of proppant packs, and consolidation of formations, among other uses.

A process for forming an adhesive agent includes reacting a diacid and a polyamine to form a reaction mixture, and then adding one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof, to form the adhesive agent.

In one embodiment of the process, the adhesive agent may be created as follows. A diacid and a polyamine are added together in a reactor at a first temperature and then heated to a second temperature. The reaction was continued at the second temperature for a first period of time until no water was further releases and the reaction product was formed. Optionally, a nitrogen purge may be performed during the first period of time. Then the one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof, to form the adhesive composition, were added to the reactor and the reaction was continued at the second temperature for a second period of time. The one or more compounds may be added dropwise. Optionally, a nitrogen purge may be performed during the second period of time. The reaction temperature was increased to a third temperature for a third period of time. After the third period of time, the composition was cool to a fourth temperature, and transferred to a receptacle, which was maintained at a fifth temperature.

The first temperature was from about 100° C. to about 185° C., for example, from about 145° C. to about 180° C. The second temperature was from about 180° C. to about 220° C., for example, from about 190° C. to about 215° C. The first period of time was from about 30 minutes to about 5 hours, for example about 1.5 hours. The second period of time was from about 30 minutes to about 5 hours, for example about 1 hour. The third temperature was from about 210° C. to about 260° C., for example, about 250° C. The third period of time was from about 20 minutes to about 3 hours, for example about 30 minutes. The fourth temperature was from about 260° C. to about 140° C., for example, about 150° C. The fourth temperature was from about 150° C. to about 110° C., for example, about 120° C.

In one embodiment, the particle material may be a proppant material formed by coating a substrate material as described herein with the adhesive composition described herein.

Proppant materials, or proppants, are generally used to increase production of oil and/or gas by providing a conductive channel in the formation. Fracturing of the subterranean formation is conducted to increase oil and/or gas production. Fracturing is caused by injecting a viscous fracturing fluid or a foam at a high pressure (hereinafter injection pressure) into the well to create a fracture. A similar effect can be achieved by pumping a thin fluid (water containing a low concentration of polymer) at a high injection rate.

As the fracture is formed, a particulate material, referred to as a “proppant” is placed in the formation to maintain the fracture in a propped condition when the injection pressure is released. As the fracture forms, the proppants are carried into the fracture by suspending them in additional fluid or foam to fill the fracture with a slurry of proppant in the fluid or foam, often referred to as a fracturing fluid or fracking (fracing) fluid. Upon release of the pressure, the proppants form a pack that serves to hold open the fractures. The propped fracture thus provides a highly conductive channel in the formation. The degree of stimulation afforded by the hydraulic fracture treatment is largely dependent upon formation parameters, the fracture's permeability, the propped fracture length, propped fracture height and the fracture's propped width. It is believed that the buoyancy additives described herein improve propped fracture length and propped fracture height because of the enhanced buoyancy that is imparted to the proppant substrate.

In one embodiment, the particle material may be a proppant formed by coating a substrate material as described herein with the adhesive composition described herein. The deposited coating may be continuous or non-continuous. If continuous, the coating may be deposited at a thickness from about 0.001 microns to about 10 microns.

In one embodiment of the proppant material, the coating of the adhesive composition may comprise from about 0.05% to about 10% by weight, such as from about 0.5% to about 4% by weight, for example, from about 0.8% to about 2% by weight, of the proppant material; and the substrate material comprises from about 90% to about 99.95% by weight, such as from about 95% to about 99.9% by weight, for example, from about 98% to about 99.8% by weight, of the proppant material. A buoyancy additive, also referred to as a buoyancy imparting additive, may be disposed on the coating of the adhesive composition of the proppant material. The buoyancy additive may be a material selected from the group consisting of a polysaccharide, a plant fiber, a phyllosilicate fiber, and combinations thereof.

The polysaccharide may be selected from the group consisting of a heteropolysaccharide, a galactomannan polysaccharide, and combinations thereof. Examples of suitable polysaccharides include guar gum, xanthan gum, locust bean gum, taxa gum, cassia gum, tragacanth gum, gum arabic or acacia gum (a mixture of polysaccharides and glycoproteins predominantly consisting of arabinose and galactose), and combinations thereof. Xanthan gum is also known as a microbial polysaccharide. Guar gum was observed to have viscosity synergy with xanthan gum.

The plant fiber may be selected from the group consisting of psyllium fiber (plant genus Plantago), rice fibers (Oryza sativa), cotton fibers (Gossypium hirsutum, Gossypium arboretum, Gossypium herbaceum, Gossypium barbadense), linen fibers, Flax fibers (Linum usitatissium), Ramie (Bohemeria nivea), Jute fibers (Corchorus capsularis), Kenaf fibers (Hibiscus cannabinus), Beach Hibisicus (Hibiscus tiliaceus), Roselle (Hibiscus sabdariffa), Urena fibers (Urena lobate), Sunn Hemp fibers (Crotalaria juncea), Hoop Vine fibers (Trichostigma octandrum), Sisal fibers (Agave sisalana), Henequen fibers (Agave foureroydes), Yucca fibers (Yucca elata), Abaca fibers (Musa textilis), Bowstring Hemp fibers (Sansevieria trifasciata, Sansevieria roxburghiana, Sansevieria hyacinthoides), New Zealand Flax fibers (Phormium tenax), Coir fibers (Cocos nucifera), Milkweed fibers (Asclepias spp.), Kapok fibers (Ceiba pentandra), Floss Silk fibers (Chorisia speciose), Devil's Claw fibers (Proboscidea parviflora), and combinations thereof.

The phyllosilicate fiber may be selected from the group consisting of Palygorskite or Attapulgite, Allophane (Hydrated Aluminum Silicate), Apophyllite (Hydrrated Potassium Sodium Calcium Silicate Hydroxide), Bannisterite (Hydrated Potassium Calcium Manganese Iron Zinc Aluminum Silicate Hydroxide), Carletonite (Hydrated Potassium Sodium Calcium Silicate Carbonate Hydroxide Fluoride), Cavansite (Hydrated Calcium Vanadate Silicate), Chrysocolla (Hydrated Copper Aluminum Hydrogen Silicate Hydroxide), Baileychlore (Zinc Iron Aluminum Magnesium Silicate Hydroxide), Chamosite (Iron Magnesium Aluminum Silicate Hydroxide Oxide), Clinochlore (Iron Magnesium Aluminum Silicate Hydroxide), Cookeite (Lithium Aluminum Silicate Hydroxide), Nimite (Nickel Magnesium Iron Aluminum Silicate Hydroxide), Pennantite (Manganese Aluminum Silicate Hydroxide), Penninite (Iron Magnesium Aluminum Silicate Hydroxide), Sudoite (Magnesium Aluminum Iron Silicate Hydroxide), Glauconite (Potassium Sodium Iron Aluminum Magnesium Silicate Hydroxide), Illite (Hydrated Potassium Aluminum Magnesium Iron Silicate Hydroxide), Kaolinite (Aluminum Silicate Hydroxide), Montmorillonite (Hydrated Sodium Calcium Aluminum Magnesium Silicate Hydroxide), Palygorskite (Hydrated Magnesium Aluminum Silicate Hydroxide), Pyrophyllite (Aluminum Silicate Hydroxide), Sauconite (Hydrated Sodium Zinc Aluminum Silicate Hydroxide), Talc (Magnesium Silicate Hydroxide), Vermiculite (Hydrated Magnesium Iron Aluminum Silicate Hydroxide), Delhayelite (Hydrated Sodium Potassium Calcium Aluminum Silicate Chloride Fluoride Sulfate), Elpidite (Hydrated Sodium Zirconium Silicate), Fedorite (Hydrated Potassium Sodium Calcium Silicate Hydroxide Fluoride), Franklinfurnaceite (Calcium Iron Aluminum Manganese Zinc Silicate Hydroxide), Franklinphilite (Hydrated Potassium Manganese Aluminum Silicate), Gonyerite (Manganese Magnesium Iron Silicate Hydroxide), Gyrolite (Hydrated Calcium Silicate Hydroxide), Leucosphenite (Hydrated Barium Sodium Titanium Boro-silicate), Biotite (Potassium Iron Magnesium Aluminum Silicate Hydroxide Fluoride), Lepidolite (Potassium Lithium Aluminum Silicate Hydroxide Fluoride), Muscovite (Potassium Aluminum Silicate Hydroxide Fluoride), Paragonite (Sodium Aluminum Silicate Hydroxide), Phlogopite (Potassium Magnesium Aluminum Silicate Hydroxide Fluoride), Zinnwaldite (Potassium Lithium Iron Aluminum Silicate Hydroxide Fluoride), Minehillite (Hydrated Potassium Sodium Calcium Zinc Aluminum Silicate Hydroxide), Nordite (Cerium Lanthanum Strontium Calcium Sodium Manganese Zinc Magnesium Silicate), Pentapnite (Hydrated Calcium Vanadate Silicate), Petalite (Lithium Aluminum Silicate), Prehnite (Calcium Aluminum Silicate Hydroxide), Rhodesite (Hydrated Calcium Sodium Potassium Silicate), Sanbornite (Barium Silicate), Antigorite (Magnesium Iron Silicate Hydroxide), Clinochrysotile (Magnesium Silicate Hydroxide), Lizardite (Magnesium Silicate Hydroxide), Orthochrysotile (Magnesium Silicate Hydroxide), Serpentine (Iron Magnesium Silicate Hydroxide), Wickenburgite (Hydrated Lead Calcium Aluminum Silicate), Zeophyllite (Hydrated Calcium Silicate Hydroxide Fluoride), and combinations thereof.

In one embodiment, the buoyancy additive may be selected from the group consisting of xanthan gum, guar gum, locust bean gum, tara gum, cassia gum, tragacanth gum, psyllium fiber, attapulgite fiber, and combinations thereof.

In one embodiment of the proppant material, the buoyancy additive may comprise from about 0.01 wt % to about 10.0 wt. %, such as from about 0.1 wt. % to about 5.0 wt. %, for example, from about 0.5 wt. % to about 2.5 wt. %, of the proppant material.

It is believed that a neutrally buoyant proppant will help reduce the cost associated with fluid viscosifying agents (such as guar gum, hydroxyethyl cellulose, and polyacrylamide) or crosslinkers (typically made of borate or metal compounds such as zirconium (Zr) and titanium (Ti) compounds) to change the viscous fluid to a pseudoplastic fluid, while allowing a higher and longer propped fracture area by remaining suspended longer and traveling farther than conventional proppant particles. Additionally, it is believed that such a neutrally buoyant proppant that has the ability to suspend in a non-gelled fracturing fluid would simplify the hydraulic fracturing process.

In one embodiment, the material comprises the substrate, the adhesive agent, the coupling agent, and the buoyancy additive. The substrate comprises from about 90 wt. % to about 99.5 wt. %, such as from about 92.9 wt. % to about 99 wt. %, for example, from about 94.95 wt. % to about 98.5 wt. % of the material. The adhesive agent comprises from about 0.1 wt. % to about 5 wt. %, such as from about 0.25 wt. % to about 3 wt. %, for example, from about 0.3 wt % to about 2 wt. % of the material. The coupling agent comprises from about 0.01 wt. % to about 0.5 wt. %, such as from about 0.02 wt. % to about 0.1 wt. %, for example, from about 0.02 wt. % to about 0.05 wt. % of the material. The buoyancy additive comprises from about 0.39 wt. % to about 4.5 wt. %, such as from about 0.73 wt. % to about 4 wt. %, for example, from about 1.18 wt. % to about 3 wt. % of the material.

In another embodiment, the material comprises the substrate, the adhesive agent, the coupling agent, the processing aid, and the buoyancy additive. The substrate comprises from about 90.5 wt. % to about 99.5 wt. %, such as from about 92 wt. % to about 99 wt. %, for example, from about 93.3 wt. % to about 98.7 wt. % of the material. The adhesive agent comprises from about 0.1 wt % to about 3 wt. %, such as from about 0.23 wt. % to about 2 wt. %, for example, from about 0.27 wt. % to about 1.5 wt. % of the material. The coupling agent comprises from about 0.01 wt. % to about 0.5 wt. %, such as from about 0.02 wt. % to about 0.4 wt. %, for example, from about 0.03 wt. % to about 0.2 wt. % of the material. The buoyancy additive comprises from about 0.3 wt. % to about 3 wt. %, such as from about 0.5 wt. % to about 2.6 wt. %, for example, from about 0.7 wt. % to about 2 wt. % of the material. The processing aid comprises from about 0.09 wt. % to about 3 wt. %, such as from about 0.25 wt. % to about 3 wt. %, for example, from about 0.3 wt % to about 3 wt. % of the material.

In another embodiment, the material comprises the substrate, the adhesive agent, the coupling agent, the internal breaker, and the buoyancy additive. The substrate comprises from about 91 wt. % to about 99.5 wt. %, such as from about 92.9 wt. % to about 99.1 wt. %, for example, from about 95 wt. % to about 98.75 wt. % of the material. The adhesive agent comprises from about 0.1 wt. % to about 3 wt. %, such as from about 0.2 wt. % to about 3 wt. %, for example, from about 0.2 wt. % to about 1.5 wt. % of the material. The coupling agent comprises from about 0.01 wt. % to about 0.5 wt. %, such as from about 0.02 wt. % to about 0.1 wt. %, for example, from about 0.02 wt. % to about 0.05 wt. % of the material. The buoyancy additive comprises from about 0.38 wt. % to about 4.5 wt. %, such as from about 0.66 wt. % to about 3.56 wt. %, for example, from about 1 wt. % to about 2.95 wt. % of the material. The internal breaker comprises from about 0.01 wt. % to about 1 wt. %, such as from about 0.02 wt. % to about 0.5 wt. %, for example, from about 0.33 wt. % to about 0.5 wt. % of the material.

The process to form the proppant material may be a batch process, a semi-continuous process, or a continuous process. The process to form the proppant material may be performed remotely at a manufacturing facility or may be manufactured at point of use, such as using a device described in United States Patent Publication US2015/0360188, which is incorporated herein by reference in its entirety not inconsistent with the description herein.

In one embodiment of the proppant formation process, a substrate material, such as sand, introduced into a mixing device. The substrate material may be heated before or after addition to a mixing device. The substrate material is heated to a temperature from about 50° C. to about 121° C., for example, about 94° C. Next, the adhesive composition, and any additives, such as a coupling agent or cross-linking agent, are added while mixing. After coating for a period of time, such as from about 1 minute to about 10 minutes, for example about 4.25 minutes, and mixing continued to obtain free-flowing particles of coated proppant. The proppant may then have a further coating process formed thereon. An example of a further coating process is for the deposition of a buoyancy additive(s) is added while mixing, such as such as from about 0.1 minutes to about 5 minutes. The buoyancy additive(s) is provided to the mixing process after the adhesive composition has been deposited on the proppant since the adhesive composition is used to bind the buoyancy additive to the proppant. The coated particles (proppant material) are discharged from the mixer and passed through a screen and the desired particle sizes of proppant are recovered. The coating on the particles may be cured during agitation in the mixer.

In another embodiment of the proppant formation process, the proppant may be formed by a real-time coating or point-of-use manufacturing process, such as at a well site, sand mine, or transload. In such a process, a substrate material, such as sand, is introduced into a mixing device. Next, the adhesive composition, and any additives, such as a coupling agent or cross-linking agent, are added while mixing. After a coating period of time, such as from about 1 minute to about 10 minutes, for example about 4.25 minutes, the coated substrate will go to a further coating process or be directly delivered to the fracturing fluid, and pumped together to the down-hole formation. An example of a further coating process is for the deposition of a buoyancy additive is added while mixing, such as from about 0.1 minutes to about 5 minutes, and which the coated substrate can be directly delivered to the fracturing fluid, and pumped together to the down-hole formation.

The mixing can take place in a device that uses shear force, extensional force, compressive force, ultrasonic energy, electromagnetic energy, thermal energy or a combination comprising at least one of the foregoing forces and energies. The mixing is conducted in processing equipment wherein the aforementioned forces are exerted by a single screw, multiple screws, intermeshing co-rotating or counter-rotating screws, non-intermeshing co-rotating or counter-rotating screws, reciprocating screws, screws with pins, barrels with pins, screen packs, rolls, rams, helical rotors, or a combination comprising at least one of the foregoing. Exemplary mixing devices are EIRICH™ mixer, WARING™ blenders, HENSCHEL™ mixers, BARBER GREEN™ batch mixers, ribbon blenders, or the like.

In an embodiment of a proppant production process, substrate material is coated in a continuous system. Substrate material enters an elongated (for example, 20-foot-long) horizontal mixer containing two horizontally mounted shafts having paddles to promote mixing the ingredients and moving them horizontally along the mixer. If employed, any additives, such as a coupling agent or cross-linking agent, are immediately added, and then the adhesive composition as described herein is added. This mixture travels down the mixer, The total time in the mixer can range from about 3-10 minutes depending on desired throughput rate.

In one embodiment of a continuous coating system in which substrate material and coating material are fed to the long horizontal oriented mixer that may be of varying length and diameter. The embodiment of the continuous coating system has from two to four horizontal shafts that run the length of the mixer. Along the shaft there are positioned multiple sets of mixing paddles mounted on the shaft. The paddles are oriented so as to insure both mixing and the transport of the substrate from the beginning of the mixer to its exit point. At various points along the mixer are positioned addition ports so chemicals may be added at prescribed rates and times. For example, there may be addition ports for additives as described herein.

The proppant materials, as described in this invention may be injected into the subterranean formation as the sole proppant in a 100% proppant pack (in the hydraulic fracture) or as a part replacement of existing commercially available ceramic and/or sand-based proppants, polymeric material-coated and/or uncoated, or as blends between those, for example, coated particles, are 5 to 50 weight % proppant materials as described herein of the total proppants injected into the well. For example, the coated proppant materials as described herein may be first placed in a well, and afterwards an uncoated proppant material may be placed in the fracture that is closest to the wellbore or fracture openings. This type of fracturing treatment is done without stopping to change the proppant and is known in the industry as a “lead-in treatment”.

In a further embodiment, proppant materials as described herein in the 50/140 mesh range, sometimes referred to as fluid loss additives, are provided as a part replacement of existing commercially available ceramic and/or sand-based proppants, polymeric material-coated and/or uncoated, or as blends between those, are 3 to 50 weight % proppant materials as described herein of the total proppants.

In a further embodiment, the process of preparing the fracking fluid may include a lead-in of neutrally buoyant proppant and then a portion of sand that is coated with the adhesive composition in the mixer (such as a blender tub), but without using the buoyancy additive directly at the blender tub. For example, a fracking fluid process could have a lead in of pre-made (possibly by an on-the-fly manufacturing process) neutrally buoyant proppant (NBP), then a significant portion of uncoated sand, and finally, a tail-in of adhesive composition coated sand near the well bore. For example, in proportions of 25%, 50%, and 25%, respectively. This would allow NBP to travel farthest into the fracture, by placing it first, and proppant flowback control, by pumping the adhesive composition coated portion last. Alternatively, conventional resin coated proppant could be pumped as a tail-in of 7-25%.

The additive composition described herein may be present in an amount in the range of from about 0.01 weight percent to about 10 weight percent, such as from about 0.1 weight percent to about 3 weight percent, for example from 0.25 weight percent to 1.5 weight percent, based on the total weight of the fracturing fluid.

The fracturing fluid may further include proppants, such as proppants made with the adhesive composition described herein, which comprise from about 1 weight percent to about 100 weight percent, such as from about 50 weight percent to about 100 weight percent, based on the total weight of the fracturing fluid. Proppant loading in the frac fluid is generally described in terms of pounds of proppant per gallon of fluid, or ppg. For example, from 0.2 to 12 ppg.

In operation, the fracturing fluid composition described herein is introduced into a subterranean formation, such as by pumping or gravity deposition, and which introduction is referred to one skilled in the art as “injecting” (or “pumping”) a fracturing fluid composition into a subterranean formation. In one embodiment, the injecting process includes introducing the fracturing fluid composition via pre-positioned perforations in specific locations and spacing along the wellbore.

In an embodiment including a proppant, such as the proppants described herein, the fracturing fluid composition injection process comprises suspending the proppants in a fracturing fluid (often referred to as a carrier fluid) to form a suspension and injecting the suspension into a subterranean formation.

In practice, the suspension is injected into a subterranean formation at high rate and high pressure, which in turn results in creating a network of fractures into the formation. The fractures are prevented from closing by the suspended proppant. The suspended proppant, such as proppants described herein, form a high permeability pathway or conduit to extract hydrocarbon fluid out of the very low permeability shale or rock formation, once the fracturing pressure is relieved and the formation starts to produce.

### EXAMPLES

Aspects and advantages of the embodiments described herein are further illustrated by the following examples. The particular materials and amounts thereof, as well as other conditions and details, recited in these examples should not be used to limit the embodiments described herein. All parts and percentages are by weight unless otherwise indicated.

### Example 1: Typical Synthesis Procedure of the Adhesives

To a four-neck flask was charged diethylenetriamine (DETA, 51.5 g, 0.5 mol). The flask was heated up to 145° C. Terephthalic acid (TPA, 41.5 g, 0.25 mol) was charged portion wise so no clumping occurs, while allowing the heating continue. The temperature was controlled between 145° C. to 180° C. After the addition was complete, and TPA was completely dissolved, the reaction was heated up to 190-215° C., and held at this temperature for 1.5 h, or until no water was further released. Nitrogen purge was used to drive the reaction to complete. To the flask was added tall oil fatty acid (TOFA) (L-5 from Ingevity, 148 g, 0.5 mol) drop wise, and the reaction continued. The addition took about 1 h. After the addition was complete, the reaction was held at 190° C. to 215° C. for 1 h. Nitrogen purge was used to drive the generated water out. The reaction was then heated up to 250° C., and held for 30 min. The reaction was then cooled down to 150° C., and the liquid brown product was transferred to a glass jar and noted as Sample 1. This reaction product may also be referred to as E1-S1 reaction product.

Samples 2-8 were prepared according to following procedure: 8 g of a selected adhesive made by using the typical synthetic procedure in Example 1 by replacing TOFA with S-rosin (CAS number 8050-09-7), was dissolved in 8 g of a selected solvent system listed in Table 1 at room temperature. S-Rosin is a rosin product commercially available from Ingevity Inc. of Charleston, S.C.

TABLE 1
Solvent used for each sample

| | | ExxonMobil's | |
|---|---|---|---|
| | dipropylenemethyl | Aromatic 150 | Methanol, |
| Sample | ether (DPM), wt. % | solvent, wt. % | wt. % |
| 2 | 40 | 50 | 10 |
| 3 | 50 | 40 | 10 |
| 4 | 60 | 30 | 10 |
| 5 | 65 | 25 | 10 |
| 6 | 70 | 20 | 10 |
| 7 | 75 | 15 | 10 |

### Example 2

The active adhesive compositions of sample 8, 9, 10, and 11 were made by using the typical synthetic procedure in Example 1 with the stoichiometry as shown in Table 2.

TABLE 2
Sample Molar Ratios

| Samples | Molar Ratios |
|---|---|
| 8 | terephthalic acid:DETA:rosin = 1:2:2 |
| 9 | terephthalic acid:DETA:rosin = 2:3.5:3 |
| 10 | terephthalic acid:DETA:rosin:TOFA = 1:2:1:1 |
| 11 | terephthalic acid:DETA:TOFA = 1:2:2 |

Sample 8, 9, 10, and 11 are formulated according to the following procedure. 8 g of a selected adhesive was dissolved in 8 g of a solvent combination (25% Aromatic 150 and 75% dipropylene glycol methyl ether) at room temperature. 2 g of Hexion's Epon 828 was added to the solution, and the resulting mixture was mixed with a spatula thoroughly to a homogeneous liquid.

### Example 3. Performance of Chemicals of this Invention on Dust Control

The following experiments are for the demonstration of dust control property of the adhesives of this invention

Ball Milling Test Method.

The dust levels of particles can be determined for particles subjected to a Ball Mill Test using a Turbidity Test. The particles are processed in the Ball Mill as follows. Into a standard eight-inch ball mill, three ceramic balls (about 2 inches in diameter) are added along with 150 grams of the material to be tested. This combination is closed and placed on the rollers at about 50 rpm. The unit is stopped at specific times, samples removed, and subjected to the Turbidity Test as described below. After being subjected to the Ball Mill Test, the particles are subjected to a Turbidity Test as follows.

Turbidity Test Method.

Equipment used was a Hach Model 2100P turbidity meter with Gelex secondary standards and a Thermolyne Maxi-Mix 1 vortex mixer. The turbidity test was performed on 5 gram samples using as reagents of 15 grams of deionized/distilled water, doped with 0.1% FSO surfactant or FS-34 surfactant and 15 grams of DuPont™ ZONYL® FSO Fluorosurfactant or DuPont™ Capstone® FS-34.

Samples are measured according to the following steps: 1) Weigh 5.00 grams of the sample to be measured and place this in the turbidity sample cell. 2) Using the Vortex mixer, agitate the sample/water mixture for 30 seconds, 3) Clean the outside of the cell with lint free paper. 4) Place the sample/cell back into the turbidimeter and read the turbidity, 30 seconds after the Vortex mixing is ended, 5) Record the turbidity in NTU units for this sample as “dust content.”

The Ball Mill Test is assumed to simulate the likely amount of dust generated due to mechanical abrasion during transportation and pneumatic transfer of proppant. The amount of dust generated is measured via the Turbidity Test.

Sample 12 was formed by dissolving the reaction product of terephthalic acid, diethylenetriamine and TOFA in an equal amount of a solvent mixture (25% aromatic 150 (heavy aromatic naphtha from ExxonMobil), and 40% 2,2-dimethyl-4-hydroxymethyl-1,3-dioxolane (Solvay SL 191) and 10% methanol)

Sample 13 was formed by dissolving the reaction product of terephthalic acid, diethylenetriamine and TOFA in an equal amount of a solvent mixture (25% aromatic 150 (heavy aromatic naphtha from ExxonMobil), and 75% polyglyme (polyglycol methyl ether)).

### Example 4: Compatibility Test

The sample to be tested is the material made in Example 1 prepared as follows. In a glass beaker, 1.0 g ethylene-vinylacetate copolymer (EVA, EVA 2850A from Celanese) and 1.0 g of the sample were heated to 120° C., and mixed manually with a spatula for 5 min. After cooled to room temperature, the mixed sample-EVA product (1:1 ratio) was broken manually. About 60 mg of the mixed sample-EVA product was used to run a thermomechanical analysis (TMA) test along with an unmodified sample, and the EVA material. The TMA tests were done on a TA Q400 thermomechanical analysis instrument, The heating procedure is: equilibrium at 25° C. for 5 min heating at 10° C./min rate until 200° C. EVA is a typical binder for hot melt adhesive.

The TMA test records the mechanical strength under heating condition. When there is a phase transition, the sample will show a change in mechanical strength, and the instrument will detect the change. It can accurately define the phase transitions at the temperature range of the test. Therefore, if two materials are not dissolved by each other, they will show their own phase transitions, which means they are not compatible. If two materials are dissolved by each other, they will form a homogenous system at the molecular level, and the resulting material will have phase transitions different from their original compositions. So, if two materials are mixed, and the TMA does not detect their original phase transitions, it means they formed a homogeneous new material; in other words, the components are compatible. The non-mixed materials were also tested.

Once a phase transition occurs, the curve will show an absorption peak. If there is another phase transition, it will show another absorption peak. If the two materials are not blended in molecular level, there will be multi-phases that have different thermal mechanical properties, and they will show phase transition at different temperature. If only one transition temperature is observed, and the temperature is different from any of the original temperature of the original components, that means a new phase is formed at molecular level. The tackifier serves as solvent for the polymer binder (normally poor mobility due to high molecular weight), provides tackiness (stickiness) for the adhesives, and help improve the wettability of the adhesive. So, a tackifier is normally a small molecular compound with high softening point, and stickiness.

An analysis of the TMA test illustrates there is only one phase transition, and the indication of only one phase transition clearly demonstrates that the two products have molecular level blending, forming a homogeneous solution. In other words, they are completely compatible, and compatibility is the basis for a compound to be a tackifier.

### Example 5: Pressure Sensitive Adhesive Properties Test

Pressure sensitive adhesive properties of viscoelastic materials were evaluated by a special method that was developed for this purpose. In the test, force as a function of time is measured for a compression/retraction type technique to evaluate pressure sensitive adhesive properties. A portion of Sample 11 was heated to 120° C. and poured onto a 100 mm thick glass plate as substrate, which was clamped to the pedestal of a Brookfield CT3 Texture Analyzer, equipped with a 21 mm diameter aluminum probe. The instrument was programmed to lower the probe at a rate of 0.02 mm s⁻¹ onto the sample and to hold position for a period of 10 seconds, as soon as a force of 1 Newton is registered and then to pull the probe from the sample at a rate of 0.5 mm s⁻¹. The initial gradual increase in force is associated with the probe approaching the sample surface to make contact with increasing force up to the target value of 1N, where it holds position for 10 seconds. Both surfaces of the aluminum probe and glass substrate are fully wetted by the sample at this stage, before the probe is retracted from the adhesive junction. The maximum force at break is used as quantitative indication of adhesive properties, compared with the initial applied force. The onset of the retraction step is noted by the fast increase in negative force which ends at the failure point at −7.6N at approximately 145 seconds, where the high negative force decline to a zero force value over a short additional distance of movement as the adhesive sample is pulled apart in strings. Subsequent inspection of the probe and substrate surfaces showed a cohesive failure mechanism with both surfaces equally wetted with sample residue.

From the test, the “negative force” is indicative of adhesive action, and an increasing measured negative force indicates increasing performance as adhesive. Also, the ratio of (−7.6:1) of maximum tension observed to original force applied is indicative of PSA performance with higher ratios indicating increasing PSA performance. Having the tension at break exceeding the original pressure applied to an approximate 7 times (7.6:1); is indicative of a very good pressure sensitive adhesive. The observation of a negative force indicates adhesion/“stickiness” and higher forces at break (maximum negative force) indicate improving adhesive performance, which is also referred to as “adhesive force”. Additionally, the ratio of input pressure applied; compared to tension (force at break) observed is an additional indication of pressure sensitive adhesive performance. A high tension at break as result of a low applied pressure indicates high performance as a pressure sensitive adhesive. On the other hand; if a high applied pressure results in a low observed tension at break; this will be low/poor performance PSA. Thus, the example shows that the adhesive composition is a pressure sensitive adhesive and also indicates high performance as a pressure sensitive adhesive.

The following examples are provided to illustrate aspects of the invention. The examples are not intended to limit the scope of the invention and they should not be so interpreted. Amounts are in weight parts or weight percentages unless otherwise indicated.

Quick Suspension Test

The test uses the equipment of: 1) Digital top loading electronic scale; 2) 30 ml sample cells: French Square Bottles, Vacuum and Ionized, Clear, Wide Mouth, Qorpak®; 3) Timer, and the reagents of: 1) deionized/distilled water and 2) deionized/distilled water, doped with 2% KCl.

Samples are measured according to the following steps: 1) Weigh 10 grams of the proppant. 2) Weigh 20 grams of water (either deionized/distilled water or deionized/distilled water, doped with 2% KCl). 3) Combine water and proppant in a 30 mL screw cap sample bottle. 4) Screw lid onto sample bottle. 5) Shake the sample bottle vigorously by hand for 1 minute. 6) Set sample bottle on level surface. 7) Record the settling time at set intervals using a lab timer. The settling time is the amount of time needed for 20% of the material, based on visual observation, to deposit in the sample bottle or deposit to the level of a visual marker on the sample bottle. Test Data is shown below in Table 3 for the referenced examples.

Overhead Stirrer Suspension Test

The test uses the equipment of: 1) Digital top-loading electronic scale; 2) 200 ml Pyrex beaker No. 1060; 3) a lab timer; 4) overhead mechanical stirrer; 5) stir blade: spiral propeller blade; 6) lab jack stand; and the reagents of: 1) deionized/distilled water, 2) deionized/distilled water, doped with 2% KCl, and 3) fracking pond water from Oklahoma, USA. Pond water is understood herein to one skilled in the art as water from a lined or unlined, open-air, excavated reservoir used to supply water for a fracking process, also referred to as a “fracking pond.”

Samples are measured according to the following steps: 1) Weigh proppant to pre-determined loading rate; 2) Weigh water to predetermined loading rate (using either deionized/distilled water, deionized/distilled water doped with 2% KCl, or pond water); 3) Add water to 200 ml beaker; 4) Place beaker on lab jack stand; 5) Raise the lab jack stand and beaker until a stir blade attached to a mechanical overhead stirrer is immersed in the water and 4 cm from the bottom of the beaker; 6) Turn on the overhead stirrer and set the speed to 500 rpm; 7) Once a vortex is uniform throughout the water in the beaker, add the pre-weighed proppant to the water; 8) Stir for 7 minutes; 9) Set the beaker containing the sample on a level surface; and 10) Record settling time at set intervals using a lab timer. Test Data is shown below in Table 4 for the referenced examples.

Light Distribution Test

The test uses the equipment of: 1) Digital top-loading electronic scale; 2) 200 ml Pyrex beaker No. 1060; 3) a lab timer; 4) an overhead mechanical stirrer; 5) stir blade: spiral propeller blade; 6) lab jack stand; 7) a flashlight; and the reagents of: 1) deionized/distilled water, 2) deionized/distilled water doped with 2% KCl, and 3) pond water from Oklahoma, USA. Pond water is understood herein to one skilled in the art as water from a lined or unlined, open-air, excavated reservoir used to supply water for a fracking process, also referred to as a “fracking pond”.

Samples are measured according to the following steps: 1) Weigh proppant to pre-determined loading rate; 2) Weigh water to predetermined loading rate (using either deionized/distilled water, deionized/distilled water doped with 2% KCl, or pond water); 3) Add water to a 200 ml beaker; 4) Place the beaker on the lab jack stand; 5) Raise lab jack stand and beaker until the stir blade is immersed in the water and 4 cm from the bottom of the beaker; 6) Turn on overhead stirrer and set the speed to 550 rpm; 7) Once a vortex is uniform throughout the water in the beaker, add the pre-weighed proppant to the water; 8) Stir for 7 minutes; 9) Place the beaker containing the sample over a bright light source (for example a flashlight); and 10) Record distribution observations at set intervals using the lab timer. Test Data is shown below in Table 4 for the referenced examples.

Breaker Test

Using a base fluid of 2% KCl (Potassium Chloride, CAS #7447-40-7, commercially available from Sigma Aldrich) prepared from tap water, various loadings of proppant (sand or treated sand), and AP breaker (Ammonium Persulfate, CAS #7727-54-0, Ammonium peroxydisulfate is commercially available from Sigma Aldrich) are tested for decrease in viscosity accompanied by proppant settling. The purpose of the test is to determine the level of breaker required to degrade the active buoyancy additive (hydrating material captive on the proppant substrate) such that the proppant no longer suspends in the 2% KCl fluid; and the viscosity of the fluid decreases to about 4 cP.

In each case, the prescribed amount of proppant (sand or treated sand) is added to the appropriate volume of room temperature 2% KCl in a glass beaker (or other container suitable for mixing and placement in a temperature-controlled bath) and mixed for 5 minutes with an overhead mechanical stirrer. Next, the target amount of ammonium persulfate (AP) breaker is added to the slurry of proppant and the mixture is stirred for 10 seconds. NOTE: To charge the target amount of AP accurately, it is recommended that a stock solution is prepared, and the AP is added to each test sample by syringe. NOTE: Since AP is not an appropriate breaker at 100° F., use of an enzyme breaker is recommended at this temperature. After mixing in the AP, the container holding the slurry is transferred to a bath maintained at the appropriate temperature and held static (no stirring). At target time intervals, the fluid is decanted from the proppant and the viscosity measured with a Fann 35 viscometer is recorded. If there are no obvious signs of the gel breaking, the viscosity should be recorded as “S” to indicate that the proppant is suspended. The viscosity is recorded as quickly as possible and the fluid returned to the storage vessel which is transferred back to the appropriate bath if the gel has not completely broken (proppant is still partially suspended, and the fluid viscosity is greater than 4 cP). NOTE: Care should be taken to be consistent in keeping the time required to take a reading consistent across samples. Since the bob and sleeve of the viscometer will be cool during the initial reading, a blank of 2% KCl at the appropriate temperature can used to warm the equipment prior to measuring the viscosity of the test sample. Since proppant particles can get into the annular space or shear gap between the cylinders of the Fann 35 viscometer and abrade the cylinders or the bob, the proppant should not be in the fluid when the viscosity is determined.

Examples with Buoyancy Additives

For the Following Examples, reference is made to the E1-S1 reaction product, which is the reaction product of Example 1, Sample 1 described herein.

### Example 6

Example 6 employs 1 kg of 40/70 mesh frac sand with coated layers of gamma-aminopropyltriethoxysilane, used as a coupling agent and commercially available form Shin Etsu, Wacker, or Momentive (A-1100); E1-S1 reaction product described herein (used as a tackifier); xanthan gum (CAS #11138-62-2) used as a gelling agent, commercially available from Wego or Economy Polymers, and CSB (used as a processing aid; it is a mixture consisting of Molasses (CAS #68476-78-8) at 61-63%, Water (CAS #7732-18-5) at 35-40%, sucrose (CAS #57-50-1) at 14.9%, and Potassium Sulfate (CAS #7778-80-5) at 10%, which is commercially available from Midwest Agri or American Crystal Sugar Company). The sand was transferred to a Littleford lab mixer. The mixer agitator was started, and the sand was heated to a temperature of 110° F. and maintained at that temperature with a heat gun. Once the temperature was achieved, 1 gram of A-1100 silane at 1 second, 10 grams of E1-S1 reaction product described herein at 15 seconds, 12.5 grams of xanthan gum at 30 seconds, and 27 grams of CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 7

Example 7 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 150° F. and maintained at that temperature with a heat gun. Once the temperature was achieved, 1 gram of A-1100 silane at 1 second, 4 grams of E1-S1 reaction product described herein at 15 seconds, 7.5 grams of xanthan gum at 30 seconds, and 30 grams of CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 8

Example 8 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 150° F. and maintained at that temperature with a heat gun. Once the temperature was achieved, 1 gram of A-1100 silane at 1 second, 10 grams of E1-S1 reaction product described herein at 15 seconds, 7.5 grams of xanthan gum at 30 seconds, and 10 grams of CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 9

Example 9 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 110° F. and maintained at that temperature with a heat gun. Once the temperature was achieved, 1 gram of A-1100 silane at 1 second, 7.15 grams of E1-S1 reaction product described herein at 15 seconds, 10.1 grams of xanthan gum at 30 seconds, and 30 grams of CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 10

Example 10 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 130° F. and maintained at that temperature with a heat gun. Once the temperature was achieved, 1 gram of A-1100 silane at 1 second, 10 grams of E1-S1 reaction product described herein at 15 seconds, 12.5 grams of xanthan gum at 30 seconds, and 10 grams CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 11

Example 11 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 110° F. and maintained at that temperature with a heat gun. Once the temperature was achieved, 1 gram of A-1100 silane at 1 second, 7.15 grams of E1-S1 reaction product described herein at 15 seconds, 10.1 grams of xanthan gum at 30 seconds, and 30 grams of CSB at 45 seconds were added at sequential intervals to the mixer. After a total mixing time of 5 minutes, the mixing was stopped and the resulting, free-flowing coated material was passed through a no. 20 US mesh sieve. The Quick Suspension Test was performed on the coated material to check for settling time.

### Example 12

Example 12 employs 1 kg of 40/70 mesh frac sand with coated layers of A-1100 silane, E 1-S1 reaction product described herein, xanthan gum, and CSB. The sand was transferred to a Littleford lab mixer. The mixer agitator was started, and the sand was heated to a temperature of 125° F. and maintained at that temperature with a heat gun. Once the temperature was achieved, 1 gram of A-1100 silane at 1 second, 6.94 grams of E1-S1 reaction product described herein at 15 seconds, 12.4 grams of xanthan gum at 30 seconds, and 19.8 grams of CSB at 45 seconds were added at sequential intervals to the mixer. After a total mixing time of 5 minutes, the mixing was stopped and the resulting, free-flowing coated material was passed through a no. 20 US mesh sieve. The Quick Suspension Test was performed on the coated material to check for settling time.

### Example 13

Example 13 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 130° F. and maintained at that temperature with a heat gun. Once the temperature was achieved, 1 gram of A-1100 silane at 1 second, 6.88 grams of E1-S1 reaction product described herein at 15 seconds, 7.5 grams of xanthan gum at 30 seconds, and 19.6 grams of CSB at 45 seconds were added at sequential intervals to the mixer. After a total mixing time of 5 minutes, the mixing was stopped and the resulting, free-flowing coated material was passed through a no. 20 US mesh sieve. The Quick Suspension Test was performed on the coated material to check for settling time.

### Example 14

Example 14 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 110° F. and maintained at that temperature with a heat gun. Once the temperature was achieved, 1 gram of A-1100 silane at 1 second, 6.2 grams of E1-S1 reaction product described herein at 15 seconds, 7.5 grams of xanthan gum at 30 seconds, and 12 grams of CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 15

Example 15 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 130° F. and maintained at that temperature with a heat gun. Once the temperature was achieved, 1 gram of A-1100 silane at 1 second, 10 grams of E1-S1 reaction product described herein at 15 seconds, 7.5 grams of xanthan gum at 30 seconds, and 30 grams of CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 16

Example 16 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 130° F. and maintained at that temperature with a heat gun. Once the temperature was achieved, 1 gram of A-1100 silane at 1 second, 10 grams of E1-S1 reaction product described herein at 15 seconds, 12.5 grams of xanthan gum at 30 seconds, and 5 grams of CSB at 45 seconds were added at sequential intervals to the mixer. After a total mixing time of 5 minutes, the mixing was stopped and the resulting, free-flowing, coated material was passed through a no. 20 US mesh sieve. The Quick Suspension Test was performed on the coated material to check for settling time.

### Example 17

Example 17 employs 1 kg of 40/70 mesh frac sand with coated layers of A-1100 silane, Hexion OWR-1466E (used as a tackifier), and psyllium fiber (Psyllium Husk, CarePsyllium 99-100 and 99-40, Plantago ovata fiber, CAS #8063-16-9, is used as a gelling agent and is commercially available from Caremoli Industry Pvt. Ltd., AEP Colloids, or Sun Psyllium Industries. The sand was transferred to a Hobart lab mixer. The mixer agitator was started, and the sand was heated to a temperature of 302° F. with a flame. Once the temperature was achieved, 0.2 gram of A-1100 silane at 7 seconds, 20 grams of OWR-1466E at 1 second, and 30 grams of psyllium fiber at 25 seconds were added at sequential intervals to the mixer. After a total mixing time of 3 minutes, the mixing was stopped and the resulting, free-flowing, coated material was passed through a no. 20 US mesh sieve, The Quick Suspension Test was performed on the coated material to check for settling time.

TABLE 3
Quick Suspension Test

| | Quick Settling Time | Quick Settling Time (hrs) |
|---|---|---|
| | (hrs) with deionized/ | with deionized/distilled |
| Example | distilled water | water and 2% KCI |
| 11 | 7 | 5 |
| 12 | 1 | 0 |
| 13 | 1 | 0 |
| 14 | 1.5 | 0.5 |
| 15 | 7 | 5 |
| 16 | 3 | 3.5 |
| 17 | 7 | 4 |
| 18 | 1 | 0 |
| 19 | 1 | 0 |
| 20 | 1.5 | 1 |
| 21 | 7 | 7 |
| 22 | 0.5 | N/A |

Table 3 above shows the results of performing the “Quick Suspension Test” for examples 11 to 22. Examples 11, 15, 17, and 21 performed very well in deionized/distilled water, by staying fully suspended in the fluid the longest time at 7 hours. Out of these examples, only example 21 maintained the same suspension time/performance in deionized/distilled water and 2% KCl, as it did in deionized/distilled water, demonstrating the superior buoyancy of this formulation.

### Example 18

Example 18 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 135° F. and maintained at that temperature with a heat gun. Once the temperature was achieved, 1 gram of A-1100 silane at 1 second, 12 grams of E1-S1 reaction product described herein at 15 seconds, 15 grams of xanthan gum at 30 seconds, and 5 grams of CSB at 45 seconds were added at sequential intervals to the mixer. After a total mixing time of 5 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg (pounds per gallon) to check for settling time and distribution of proppant particles in deionized/distilled water doped with 2% KCl and pond water. Pond water is understood herein to one skilled in the art as water from a lined or unlined, open-air, excavated reservoir used to supply water for a fracking process, also referred to as a “fracking pond.”

### Example 19

Example 19 employs 1 kg of 40/70 mesh frac sand with coated layers of A-1100 silane, E1-S1 reaction product described herein, xanthan gum, and CSB. The sand was transferred to a Littleford lab mixer. The mixer agitator was started, and the sand was heated to a temperature of 142° F. and maintained at that temperature with a heat gun. Once the temperature was achieved, 1 gram of A-1100 silane 1 second, 14 grams of E1-S1 reaction product described herein at 15 seconds, 17.5 grams of xanthan gum at 30 seconds, and 5 grams of CSB at 45 seconds were added at sequential intervals to the mixer. After a total mixing time of 5 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg (pounds per gallon) to check for settling time and distribution of proppant particles in deionized/distilled water doped with 2% KCl and pond water.

### Example 20

Example 20 employs 1 kg of 40/70 mesh frac sand with coated layers of A-1100 silane, E1-S1 reaction product described herein, xanthan gum, guar gum (CAS #9000-30-0, Ecopol-5000, powdered gel, or Carboxymethyl Hydroxypropyl Guar Gum/CMHPG Guar/Anionic Guar Derivative, used as a gelling agent, and commercially available from Wego, Chemtol Pty Ltd., or Economy Polymers), and CSB. The sand was transferred to a Littleford lab mixer. The mixer agitator was started, and the sand was heated to a temperature of 142° F. and maintained at that temperature with a heat gun. Once the temperature was achieved, 1 gram of A-1100 silane at 1 second, 14 grams of E1-S1 reaction product described herein at 15 seconds, 8.75 grams of xanthan gum at 30 seconds, 8.75 guar gum at 30 seconds, and 5 grams of CSB at 45 seconds were added at sequential intervals to the mixer. After a total mixing time of 5 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg (pounds per gallon) to check for settling time and distribution of proppant particles in deionized/distilled water doped with 2% KCl and pond water.

### Example 21

Example 21 employs 1 kg of 40/70 mesh frac sand with coated layers of A-1100 silane, E1-S1 reaction product described herein, xanthan gum, guar gum, and CSB. The sand was transferred to a Littleford lab mixer. The mixer agitator was started, and the sand was heated to a temperature of 130° F. and maintained at that temperature with a heat gun. Once the temperature was achieved, 1 gram of A-1100 silane at 1 second, 14 grams of E1-S1 reaction product described herein at 15 seconds, 10 grams of xanthan gum at 30 seconds, 10 grams of guar gum at 30 seconds, and 5 grams of CSB at 45 seconds were added at sequential intervals to the mixer. After a total mixing time of 5 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 22

Example 22 employs 1 kg of 40/70 mesh frac sand with coated layers of A-1100 silane, E1-S1 reaction product described herein, xanthan gum, guar gum, and CSB. The sand was transferred to a Hobart lab mixer. The mixer agitator was started, and the sand was heated to a temperature of 350° F. with a flame. Once the temperature was achieved, 14 grams of E1-S1 reaction product described herein at 1 second, 1 gram of A-1100 silane at 7 seconds, 8.75 grams of xanthan gum at 22 seconds, 8.75 grams of guar gum at 22 seconds, and 5 grams of CSB at 37 seconds were added at sequential intervals to the mixer. After a total mixing time of 3 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 23

Example 23 employs 1 kg of 40/70 mesh frac sand with coated layers of A-1100 silane, E1-S1 reaction product described herein, xanthan gum, guar gum, water, and CSB. The sand was transferred to a Hobart lab mixer. The mixer agitator was started, and the sand was heated to a temperature of 350° F. with a flame. Once the temperature was achieved, 14 grams of E1-S1 reaction product described herein at 1 second, 1 gram of A-1100 silane at 7 seconds, 8.75 grams of xanthan gum at 22 seconds, 8.75 grams of guar gum at 22 seconds, 20 grams of water at 37 seconds was used to cool the reaction, and 5 grams of CSB at 1 minute and 30 seconds were added at sequential intervals to the mixer. After a total mixing time of 3 minutes, the mixing was stopped, and the resulting, free-flowing, coated material was passed through a no. 20 US mesh sieve. The Overhead Stirrer Suspension Test and Light Distribution Test were performed on the coated material at a load rate of 2 ppg to check for settling time and distribution of proppant particles in deionized/distilled water doped with 2% KCl and pond water.

### Example 24

Example 24 employs 1 kg of 40/70 mesh frac sand with coated layers of A-1100 silane, E1-S1 reaction product described herein, xanthan gum, guar gum, and CSB. The sand was transferred to a Hobart lab mixer. The mixer agitator was started, and the sand was heated to a temperature of 350° F. with a flame. Once the temperature was achieved, 20 grams of CSB at 1 second, 0.4 grams of A-1100 silane at 15 seconds, 14 grams of E1-S1 reaction product described herein at 30 seconds, 8.75 grams of xanthan gum at 45 seconds, 8.75 grams of guar gum at 45 seconds, and 5 grams of CSB at 1 minute were added at sequential intervals to the mixer. After a total mixing time of 4 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 25

Example 25 employs 1 kg of 40/70 mesh frac sand with coated layers of A-1100 silane, E1-S1 reaction product described herein; xanthan gum, guar gum, and CSB. The sand was transferred to a Hobart lab mixer. The mixer agitator was started, and the sand was heated to a temperature of 200° F. with a flame. Once the temperature was achieved, 14 grams of E1-S1 reaction product described herein at 1 second, 0.4 grams of A-1100 silane at 7 seconds, 8.75 grams of xanthan gum at 22 seconds, 8.75 grams of guar gum at 22 seconds, and 5 grams of CSB at 37 seconds were added at sequential intervals to the mixer. After a total mixing time of 3 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 26

Example 26 employs 1 kg of 40/70 mesh frac sand with coated layers of A-1100 silane, E1-S1 reaction product described herein, xanthan gum, guar gum, sodium alginate (CAS #9005-38-3, algin, consists mainly of the sodium salt of alginic acid, which is a mixture of polyuronic acids composed of residues of D-mannuronic acid and L-guluronic acid. Sodium Alginate is obtained mainly from algae belonging to the Phaeophyceae. It is used as a gelling agent and is commercially available from Wego or McKinley Resources, Inc.), and CSB. The sand was transferred to a Hobart lab mixer. The mixer agitator was started, and the sand was heated to a temperature of 200° F. with a flame. Once the temperature was achieved, 14 grams of E1-S1 reaction product described herein at 1 second, 0.4 grams of A-1100 silane at 7 seconds, 8.75 grams of xanthan gum at 22 seconds, 4.37 grams of guar gum at 22 seconds, 4.37 grams of sodium alginate at 22 seconds, and 5 grams of CSB at 37 seconds were added at sequential intervals to the mixer. After a total mixing time of 3 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 27

Example 27 employs 1 kg of 40/70 mesh frac sand with coated layers of E-silane ((3-glycidyloxypropyl)trimethoxysilane, CAS #2530-83-8 used as a cross linker commercially available from Shin Etsu, Wacker, or Momentive), Crude Glycerin of 82-85% glycerin as described herein (Crude Glycerin, Crude Glycerol, Biodiesel Derived Glycerol, a mixture of Glycerin CAS #56-81-5, Sodium Chloride CAS # 7647-14-15, Sodium Sulfate 7757-82-6, Water CAS #7732-18-5, and MONG (Matter Organic, Non Glycerol)), used as a tackifier and a processing aid, commercially available from Altris Industrial Services, LLC, xanthan gum, and guar gum. The sand was transferred to a Hobart lab mixer. The mixer agitator was started, and the sand was heated to a temperature of 200° F. with a flame. Once the temperature was achieved, 3 grams of Crude Glycerin (of 82-85% glycerin as described herein) at 1 second, 0.4 grams of E-silane at 7 seconds, 6.25 grams of xanthan gum at 15 seconds, 6.25 grams of guar gum at 15 seconds, and 3 grams of Crude Glycerin (of 82-85% glycerin as described herein) at 22 seconds were added at sequential intervals to the mixer. After a total mixing time of 3 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 28

Example 28 employs 1 kg of 40/70 mesh frac sand with coated layers of E-silane, Crude Glycerin (of 92-95% glycerin as described herein, glycerin, a mixture of 1,2,3-propanetriol and fatty acid methyl esters, components: glycerin as glycerol CAS #56-81-5, water CAS #7732-18-5, potassium sulfate CAS #7778-80-5, fatty acid esters CASH 68937-84-8, and methanol CAS #7732-18-5, used as a tackfier and a processing aid), xanthan gum, and guar gum. The sand was transferred to a Hobart lab mixer. The mixer agitator was started, and the sand was heated to a temperature of 200° F. with a flame. Once the temperature was achieved, 3 grams of Crude Glycerin (of 92-95% glycerin as described herein) at 1 second, 0.4 grams of E-silane at 7 seconds, 6.25 grams of xanthan gum at 15 seconds, 6.25 grams of guar gum at 15 seconds, and 3 grams of Crude Glycerin (of 92-95% glycerin as described herein) at 22 seconds were added at sequential intervals to the mixer. After a total mixing time of 3 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 29

Example 29 employs 1 kg of 40/70 mesh frac sand with coated layers of E-silane, E1-S1 reaction product described herein, xanthan gum, and guar gum. The sand was transferred to a Hobart lab mixer. The mixer agitator was started, and the sand was heated to a temperature of 200° F. with a flame. Once the temperature was achieved, 4 grams of E1-S1 reaction product described herein at 1 second, 0.4 grams of E-silane at 7 seconds, 6.25 grams of xanthan gum at 22 seconds, and 6.25 grams of guar gum at 22 seconds were added at sequential intervals to the mixer. After a total mixing time of 3 minutes, the mixing was stopped and the resulting, free-flowing, coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

### Example 30

Example 30 employs 1 kg of 40/70 mesh frac sand with coated layers of E-silane, E 1-S1 reaction product described herein, sodium percarbonate (used as an internal oxidizing breaker and processing aid), xanthan gum, and guar gum. The sand was transferred to a Hobart lab mixer. The mixer agitator was started, and the sand was heated to a temperature of 200° F. with a flame. Once the temperature was achieved, 3 grams of E1-S1 reaction product described herein at 1 second, 0.34 grams of sodium percarbonate at 3 seconds, 0.4 grams of E-silane at 7 seconds, 6.25 grams of xanthan gum at 22 seconds, and 6.25 grams of guar gum at 22 seconds were added at sequential intervals to the mixer. After a total mixing time of 3 minutes, the mixing was stopped and the resulting, free-flowing coated material was passed through a no. 20 US mesh sieve. The Overhead Stirrer Suspension Test and Light Distribution Test were performed on the coated material at a loading rate of 2 ppg to check for settling time and distribution of proppant particles in deionized/distilled water doped with 2% KCl and pond water.

TABLE 4

| | Overhead Stirrer | Quick | |
|---|---|---|---|
| | Settling Time (hrs) | Settling | |
| | with deionized/ | Time (hrs) | |
| | distilled water | with | Light distribution Test |
| Example | and 2% KCI | pond water | Observation |
| 18 | 4 | 4 | Distributed throughout |
| | | | fluid but lacked equal |
| | | | particle separation |
| 19 | 4 | 4 | Distributed throughout |
| | | | fluid but slightly lacked |
| | | | equal particle separation |
| 20 | 7 | 7 | Distributed throughout |
| | | | fluid and had uniform |
| | | | particle separation |
| 21 | 2 | 2 | Distributed throughout |
| | | | fluid but slightly lacked |
| | | | equal particle separation |
| 22 | 0 | 0 | N/A |
| 23 | 0 | 0 | N/A |
| 24 | 0 | 0 | N/A |
| 25 | 7 | 7 | Distributed throughout |
| | | | fluid and had uniform |
| | | | particle separation |
| 26 | 0 | 0 | N/A |
| 27 | 7 | 7 | Distributed throughout |
| | | | fluid and had uniform |
| | | | particle separation |
| 28 | 7 | 7 | Distributed throughout |
| | | | fluid and had uniform |
| | | | particle separation |
| 29 | 7 | 7 | Distributed throughout |
| | | | fluid and had uniform |
| | | | particle separation |
| 30 | 4 | 4 | Distributed throughout |
| | | | fluid but slightly lacked |
| | | | equal particle separation |

Table 4 shows the suspension time and particle uniformity in the fluid for examples 18 through 30. A value of 0 in the settling tests means that all material settled in <1 hour. Some of the examples, such as 18, 19, 21, and 30, demonstrated good suspension, but did not demonstrate uniform particle dispersion in the fluid. Most of the examples showed a direct relationship of uniform particle distribution and suspension time. In the hydraulic fracturing process, examples having particles with extended suspension time, uniform distribution throughout the fluid, and equal particle separation are expected to have the best performance in terms of creating longer propped fractures.

Breaker Testing

The six Figures herein show the breaker test results for examples 27, 30, and 29. All of the examples (proppant) were loaded at a rate of 2 ppg and heated to 160° F. The viscosity for each example slurry was measured 4 times over ˜24 hours. The examples were tested at 6 different loading rates of the AP breaker, ranging from 0 to 16 gpt (gallons per thousand gallons of 2% KCl fluid). Even though these examples had great performance in suspension time and uniform particle distribution, they did not break sufficiently within 24 hours at room temperature to reach fluid viscosity of <4 cP.

Better breaking of the hydrated buoyancy additive captive on the example particles can translate into improved hydrocarbon production after the stimulation treatment with the neutrally buoyant particles of the invention. It is important that the gel around each particle of the substrate breaks/cleans up and leads to a high degree of permeability in the placed proppant pack. The chart in FIG. 1 demonstrates the performance of three different examples in the breaker test. Each sample was loaded at a concentration of 2 ppg. The samples were heated to and maintained at 160° F. for up to 24 hours. The viscosity of each sample was taken at systematic intervals of time. For the testing shown in FIG. 1, there was no oxidizing breaker added and each example solution was only heated to break and clean up the hydrated buoyancy additive. The purpose of this testing was to determine the effect of heat on the viscosity of the solution over time. The intent was to use this testing as a control for additional experiments. As seen in FIG. 1, none of the solutions broke sufficiently over a 24-hour period with the addition of heat alone. To consider the gel around each particle sufficiently broken, the solution viscosity would need to decrease to about 4 cP or lower.

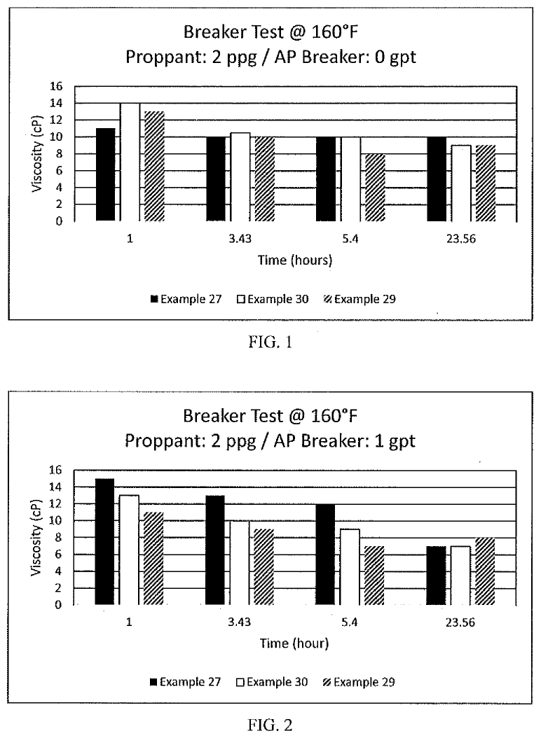

The chart shown in FIG. 2 demonstrates the performance of three different examples in the breaker test. Each sample was loaded at a concentration of 2 ppg. The samples were heated to and held at 160° F. for up to 24 hours, The viscosity of each sample was taken at systematic intervals of time. The chart (FIG. 2) displays how the heat and breaker affect the viscosity of the buoyant proppant fluid slurry over time. In this testing 1 gpt of oxidizing breaker (ammonium persulfate, AP) was added. As seen in the chart above (FIG. 2); the viscosity of each solution decreased over time, but the gel of the hydrated buoyancy additive did not sufficiently break within a 24-hour period. To consider the gel around each particle sufficiently broken; the solution viscosity would need to decrease to about 4 cP or lower.

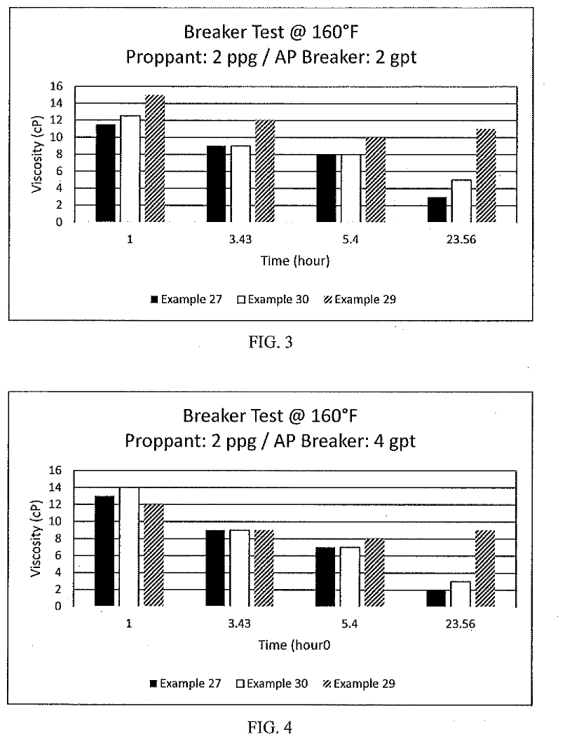

The chart shown in FIG. 3 demonstrates the performance of three different examples in the breaker test. Each sample was loaded at a concentration of 2 ppg. The samples were heated to and held at 160° F. for up to 24 hours. The viscosity of each sample was taken at systematic intervals of time. FIG. 3 shows how the heat and breaker affect the viscosity of the buoyant proppant fluid slurry over time. In this testing, 2 gpt of AP breaker was added. As seen in FIG. 3, example 27 broke within a 24-hour period as indicated by a solution viscosity of less than 4 cP. The solution viscosity for examples 30 and 29 generally decreased over time, but the gel of the hydrated buoyancy additive did not sufficiently break within a 24-hour period. To consider the gel around each particle sufficiently broken, the solution viscosity would need to decrease to about 4 cP or lower.

The chart shown in FIG. 4 demonstrates the performance of three different examples in the breaker test. Each sample was loaded at a concentration of 2 ppg. The samples were heated to and held at 160° F. for up to 24 hours. The viscosity of each sample was taken at systematic intervals of time. FIG. 4 shows how the heat and breaker affect the viscosity of the buoyant proppant fluid slurry over time. In this testing, 4 gpt of AP breaker was added. As seen in FIG. 4, examples 27 and 30 broke within a 24-hour period as indicated by the viscosity of each solution decreasing to less than 4 cP. The solution viscosity for example 29 generally decreased over time, but the gel of the hydrated buoyancy additive did not sufficiently break on each particle within a 24-hour period as indicated by a final viscosity of greater than 4 cP. To consider the gel around each particle sufficiently broken, the solution viscosity would need to decrease to about 4 cP or lower.

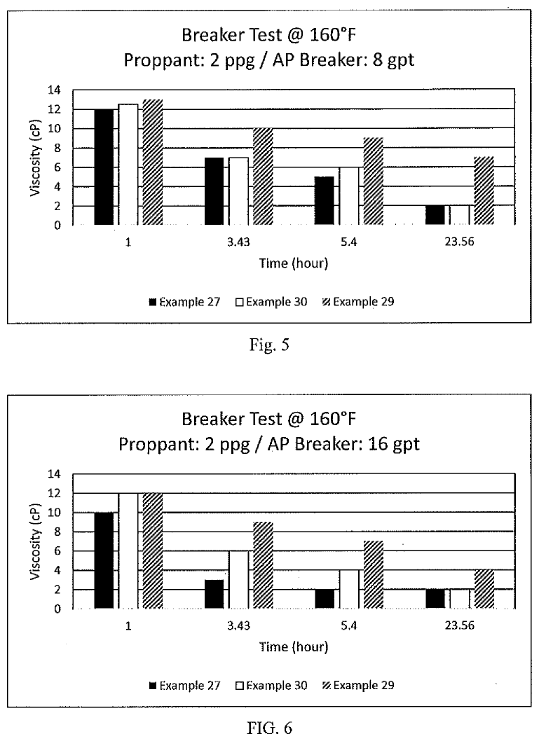

The chart shown in FIG. 5 demonstrates the performance of three different examples in the breaker test. Each sample was loaded at a concentration of 2 ppg. The samples were heated to and held at 160° F. for up to 24 hours. The viscosity of each sample was taken at systematic intervals of time. FIG. 5 shows how the heat and breaker affect the viscosity of the buoyant proppant fluid slurry over time. In this testing, 8 gpt of AP breaker was added. As seen in FIG. 5, for examples 27 and 30, the gel around each particle sufficiently broke within a 24-hour period as indicated by a final slurry viscosity of less than 4 cP. The solution viscosity for example 29 decreased over time, but the gel of the hydrated buoyancy additive did not sufficiently break on each particle within a 24-hour period as indicated by a final viscosity of greater than 4 cP. To consider the gel around each particle sufficiently broken, the solution viscosity would need to decrease to about 4 cP or lower.

The chart shown in FIG. 6 demonstrates the performance of three different examples in the breaker test. Each sample was loaded at a concentration of 2 ppg. The samples were heated to and held at 160° F. for up to 24 hours. The viscosity of each sample was taken at systematic intervals of time. FIG. 6 shows how the heat and breaker affect the viscosity of the buoyant proppant fluid slurry over time. In this testing, 16 gpt of AP breaker was added. As seen in FIG. 6, the gel of the hydrated buoyancy additive on each particle sufficiently broke within a 24-hour period in each fluid slurry, as indicated by a viscosity of ≤4 cP for each example.

While the foregoing is directed to embodiments of the present disclosure, other and further embodiments of the disclosure may be devised without departing from the basic scope thereof, and the scope thereof is determined by the claims that follow.

What is claimed is:

1. A material comprising:
a substrate; and
an adhesive composition disposed on the substrate, wherein the adhesive composition comprises:
an adhesive agent;
a coupling agent; and
optionally, a processing aid, an internal breaker, or both; and
a buoyancy additive disposed on the adhesive composition.

2. The material of claim 1, wherein the adhesive agent comprises a material selected from the group of:
a polyol,
a N-cyclohexylsulfamate compound,
a phenol-aldehyde resole resin,
a reaction product of diglycidyl ether or a polyacid, a polyamine, and one or more compounds selected from the group consisting of a branched aliphatic acid having C2-C26 alkyl group, a cyclic aliphatic acid with C7-C30 cyclic aliphatic group, a linear aliphatic acid having C2-C26 alkyl group, and combinations thereof,
and combinations thereof.

3. The material of claim 2, wherein the polyol comprises a polyether polyol, or a compound selected from the group consisting of propane-1,2,3-triol, glycerol, propanetriol, 1,2,3-trihydroxypropane, 1,2,3-propanetriol, crude glycerin, and combination thereof, or both.

4. The material of claim 2, wherein the N-cyclohexylsulfamate compound comprises sodium N-cyclohexylsulfamate, molasses, and combinations thereof.

5. The material of claim 1, wherein the coupling agent comprises a material selected from the group of silane, amino silanes, epoxy silanes, mercapto silanes, hydroxy silanes, ureido silanes, and combinations thereof.

6. The material of claim 1, wherein the material comprises:
from about 90 to about 99.5 of the substrate;
from about 0.1 to about 5 of the adhesive agent;
from about 0.01 to about 0.5 of the coupling agent; and
from about 0.39 to about 4.5 of the buoyancy additive, wherein the total amount of components comprise 100 wt % of the material.

7. The material of claim 6, further comprising:
from about 0 to about 3 of the processing agent, and
from about 0 to about 1 of the internal breaker, wherein the total amount of components comprise 100 wt % of the material.

8. The material of claim 1, wherein the buoyancy additive comprises a material selected from the group consisting of a polysaccharide, a plant fiber, a phyllosilicate fiber, and combinations thereof.

9. The material of claim 7, wherein the polysaccharide is selected from the group consisting of guar gum, xanthum gum, locust bean gum, tara gum, cassia gum, tragacanth gum, gum arabic, and combinations thereof.

10. The material of claim 1, wherein the buoyancy additive is selected from the group consisting of xanthan gum, guar gum, locust bean gum, tara gum, cassia gum, tragacanth gum, psyllium fiber, attapulgite fiber, and combinations thereof.

11. The material of claim 1, wherein the adhesive composition further includes an oxidizing agent.

12. The material of claim 11, wherein the one or more additives comprises from about 0.03 wt. % to about 0.10 wt. % of the material.

13. The material of claim 1, wherein the substrate comprises a polymeric material coating.
